(19) United States
(12) Patent Application Publication
(10) Pub. No.: US 2017/0270517 A1
(43) Pub. Date: Sep. 21, 2017

(54) PARTIALLY ACTIVATED TOKENS WITH LIMITED FUNCTIONALITY

(71) Applicants: Madhu Vasu, Foster City, CA (US); Prasanna L. Narayan, San Ramon, CA (US)

(72) Inventors: Madhu Vasu, Foster City, CA (US); Prasanna L. Narayan, San Ramon, CA (US)

(21) Appl. No.: 15/461,279

(22) Filed: Mar. 16, 2017

Related U.S. Application Data
(60) Provisional application No. 62/310,591, filed on Mar. 18, 2016.

(51) Int. Cl. G06Q 20/36; G06K 7/10; G06Q 20/40; G07C 9/00

(52) U.S. Cl. CPC G06Q 20/3674; G07C 9/00309; G07C 9/00896; G06K 7/10297; G06Q 20/4018

(57) ABSTRACT

Embodiments are described that are directed to optimizing the provisioning of account credentials to mobile devices utilizing mobile wallets. In some embodiments, provisioned credentials may be immediately usable for restricted applications, and then fully activated at a later time after the user is authenticated.

### CROSS-REFERENCE TO RELATED APPLICATIONS

This application is a non-provisional application of and claims the benefit of the filing date of U.S. Provisional Application No. 62/310,591, filed on Mar. 18, 2016, which is herein incorporated by reference in its entirety for all purposes.

### FIELD

Aspects of the disclosure relate to computing technologies. In particular, aspects of the disclosure relate to device provisioning technologies, such as systems, methods, apparatuses, and computer-readable media for provisioning mobile devices with account credentials.

### BACKGROUND

Attempts have been made to utilize mobile device technology to replace conventional physical items carried by individuals, such as various cards carried in bags or wallets. For example, one way to provide mobile transaction functionality has been realized by provisioning account information (e.g., access credentials) directly onto a secure element (SE) of a mobile device that may be equipped with Near Field Communication (NFC) chipset. An SE may be a smart card chip that is capable of storing multiple applications and/or account specific information that may not be easily accessed by external parties. NFC technology is commonly used for contactless short-range communications based on radio frequency identification (RFID) standards using magnetic field induction to enable communication between electronic devices. This short-range high frequency wireless communications technology allows devices to exchange data over a short distance (e.g., a few centimeters). Such mobile devices may thus use a mobile application that, like a conventional physical wallet, may “contain” a user's access badges, identification cards, health insurance cards, member cards, transportation cards, loyalty cards, credit cards, event tickets, etc.

To this end, user account credentials may be provisioned onto mobile devices. Once these credentials have been provisioned onto the mobile device, an NFC-enabled device may transact with (e.g., transfer information to) another NFC-enabled device by placing the devices near each other. For example, a user can place the mobile device near an access gate to transmit access credential to the access gate, and thereby gain entrance to a secure area.

In a typical provisioning process, a user may submit a request to have credentials provisioned. Before any provisioning takes place, the user may be asked to answer security questions, or otherwise go through an authentication process. Once authenticated, the credentials can be provisioned through a number of back-and-forth messages between the user's mobile device, a provisioning service, and potential other intermediary entities. Finally, once the authentication and provisioning communications are finished, the user may be able to use the provisioned credentials for a transaction.

This process is problematic, as the user may experience a long wait before the process is completed and the credentials can be utilized. By the time the credentials are usable, the user may no longer need them, or may have forgotten about them. As mentioned above, delays in credential provisioning can be caused by multiple provisioning-related messages as well as user authentication processes, which can take both time and effort. User authentication processes sometimes cause users to abandon provisioning processes. For example, a user may attempt to load an access card to a mobile device when approaching an access gate. In that moment, it may be inconvenient to perform an authentication process, so the user may abandon the access card provisioning process.

Embodiments of the invention address these and other problems, individually and collectively.

### BRIEF SUMMARY

Embodiments of the present invention are directed at optimizing the provisioning of credentials (e.g., payment credentials) to mobile devices utilizing mobile wallets. In some embodiments, a credential can be provisioned in a partially active state, such that the credential can be immediately used for a restricted set of transactions. As a result, there may be no delay (or a only a short wait) between requesting credential provisioning and using the provisioned credential.

Security is maintained even when the user has not been authenticated, as damage from fraudulent use is limited and controlled by the restrictions on the partially active credential. The credential can be fully activated after the user is authenticated.

One embodiment of the invention is directed to a method. The method performed comprises receiving, at a server computer, a provisioning request to provision a credential to a mobile device. The credential is associated with an account of a user. The method also includes transmitting provisioning scripts to be executed by the mobile device to cause the credential to be stored at the mobile device in a partially active state. The partially active state allows the mobile device to utilize the credential for restricted transactions.

Another embodiment of the invention is directed to a server computer configured to perform the above-described method.

Another embodiment of the invention is directed to a method comprising receiving, by a mobile device, provisioning scripts for provisioning a credential associated with an account of a user. The method also includes executing the provisioning scripts. Executing the provisioning scripts causes the credential to be stored at the mobile device in a partially active state. The partially active state allows the mobile device to utilize the credential for restricted transactions.

Another embodiment of the invention is directed to a mobile device configured to perform the above-described method.

These and other embodiments of the invention are described in further detail below.

### BRIEF DESCRIPTION OF THE DRAWINGS

FIG. 1 illustrates a block diagram including entities in a transaction system.

FIG. 2 illustrates a block diagram including entities in an account provisioning system according to some embodiments of the present invention.

FIG. 3 illustrates a combined sequence and flow diagram depicting account provisioning, including low risk and high risk provisioning, in an account provisioning system according to some embodiments of the present invention.

FIG. 4 illustrates a combined sequence and flow diagram depicting medium risk account provisioning in an account provisioning system with respect to FIG. 2 according to some embodiments of the present invention.

FIG. 5 illustrates a combined sequence and flow diagram depicting token verification for full activation in an account provisioning system with respect to FIG. 2 according to some embodiments of the present invention.

FIG. 6 illustrates a flow in a server computer for account provisioning according to some embodiments of the present invention.

FIG. 7 illustrates a combined sequence and flow diagram depicting two dynamic verification value validation configurations in an account provisioning system according to some embodiments of the present invention.

FIG. 8 illustrates a block diagram of a transaction system for accessing a building, according to an embodiment of the invention.

### DETAILED DESCRIPTION

Embodiments of the present invention are directed at optimizing the provisioning of payment credentials to mobile devices utilizing mobile wallets. In some embodiments, payment credentials can be provisioned to a mobile device in an partially active state that allows the payment credentials to be utilized for some restricted purchases. Upon completion of the authentication process, the provisioned partially active credentials may be activated for full use (e.g., some or all restrictions can be lifted).

As a result, there may be no delay after requesting that a credential is provisioned to a mobile device, since the partially active credential can be used right away. Also, full activation can take place promptly, as once the user is authenticated, a single message can be sent to the mobile device to fully activate the token. In other embodiments, no messages need be sent to the mobile device, as the restrictions can be managed (and lifted) at backend servers. Security risks are still controlled, as any potential fraudulent use is limited by the restricted set of transactions.

Embodiments of the invention apply to any suitable type of credential that can be provisioned onto a mobile device. For example, embodiments allow provisioning of identification card credentials, health insurance card credentials, member card credentials, transportation card credentials, loyalty card credentials, payment credentials, event ticket credentials, access badge credentials (e.g., an access code), secure data access credentials, etc. Embodiments allow tokenized versions of these credentials to be provisioned to a mobile device.

Additionally, embodiments allow any suitable type of credential to be provisioned in a partially active state with any suitable transaction restrictions. For example, any suitable type of partially active credential may be restricted to a certain number of uses (e.g., up to 5 uses), a certain area (e.g., a zip code, building, service provider location, etc.), a certain time of day (e.g., business hours), a certain day of the week (e.g., weekdays only or weekends only), and any other suitable limitation. Once the user is authenticated and the credential fully activated, these restrictions can be lifted.

Further, different types of credentials can have different types of additional restrictions. For example, a partially active identification card credential may allow the user to board a plane, but not to open a bank account. A partially active health insurance card credential may allow a user to schedule an appointment, but not access personal health history files. A partially active member card credential may allow a user to exercise some membership privileges (e.g., access a members-only room), but not make charges to a membership tab or account. A partially active transportation card credential may allow a user to take a limited amount of rides (e.g., up to 3, 4, or 5 rides) or short rides (e.g., local transportation), but not unlimited rides or long-distance rides. A partially active loyalty card credential may allow a user to accrue loyalty points, but not use loyalty points. A partially active payment credential may allow a user to make small transactions (e.g., transaction under $25, $50, or $100), but not transactions for greater amounts. A partially active event ticket credential may allow a user to enter a stadium, but not access seat or private room. A partially active access badge credential (e.g., an access code) may allow a user to access a low-security area (e.g., enter a front door of a building), but not a high-security area (e.g., an office, a room with sensitive information, etc.). A partially active secure data access credential may allow a user to access some information or functionality (e.g., view recent emails in an email account) for a limited amount of time (e.g., access an email account or secure database for up to 5 minutes), but not access other information or functionality (e.g., view all emails or write emails from an email account).

Embodiments of the present invention are directed at optimizing secure element (“SE”) application provisioning on mobile devices with mobile wallets that have a consumer enrollment process. Some embodiments are directed at provisioning card data on a secure element by generating and delivering multiple possible personalization scripts for implementing multiple provisioning outcomes in one communication. Accordingly, an embodiment optimizes secure element application provisioning by providing all possible provisioning scripts to a wallet provider or other payment account manager before card data activation is completed, so that the eventual activation of a provisioned card account on a secure account requires less communication and/or computational resources at the time of activation. Accordingly, card application data may be provisioned on a secure element of a mobile device while only requiring a single provisioning message from a provisioning system, which can minimize the number of messages between a mobile wallet server and a payment processing network service provider.

Thus, embodiments of the invention provide efficient provisioning processes that can selectively provide enhanced authentication of a user in a single, efficient process.

Prior to discussing embodiments of the invention, a description of some terminology is presented to assist with understanding this disclosure.

A “mobile device” may include any suitable device that is moveable. In some embodiments, a mobile device may be any suitable electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g. when a device has remote access to a network by tethering to another device—i.e. using the other device as a modem—both devices taken together may be considered a single mobile device).

As used herein, a “risk score” may be an evaluation of threat. For example, a risk score can include an arbitrary designation or ranking that represents the risk associated that a transaction or provisioning request may be fraudulent. The risk score may be represented by a number (and any scale), a probability, or in any other relevant manner of conveying such information. The risk score may comprise an aggregation of information about a transaction, including transaction information, account information, and verification information as defined above. The risk score may be used by any authorizing entity (such as a merchant or an issuer) in determining whether to approve a transaction. The risk score may comprise and/or utilize both current transaction information and past transaction information, and may weight such information in any suitable manner.

A “physical device” may include any suitable physical object. For example, a physical device can include an item possessed by an individual. In some embodiments, a physical device can include information about a transaction account, and may be able to provide the transaction account information to an access device for a transaction. Examples of physical devices include items carried in a wallet, such as an entry device (e.g., an access card or access badge), an identification card (e.g., a driver's license), a transportation card (e.g., a bus pass), and a payment device (e.g., a credit card, debit card, etc.).

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. A payment device may be used to make a payment transaction. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of payment devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode. In some embodiments, a mobile device can function as a payment device (e.g., a mobile device can store and be able to transmit payment credentials for a transaction).

As used herein, a “payment account” (which may be associated with one or more payment devices) may refer to any suitable payment account including a credit card account, a checking account, a prepaid account, etc.

As used herein, “identification information” may include any suitable information associated with an account (e.g., a payment account and/or payment device associated with the account). Such information may be directly related to the account or may be derived from information related to the account. Examples of account information may include a PAN (Primary Account Number or “account number”), user name, expiration date, CW (Card Verification Value), dCVV (Dynamic Card Verification Value), CVV2 (Card Verification Value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors).

A “credential” may be any suitable information that serves as reliable evidence of worth, ownership, identity, or authority. A credential may be a string of numbers, letters, or any other suitable characters that may be present or contained in any object or document that can serve as confirmation. Examples of credentials include identification credentials (e.g., a driver's license number), health insurance credentials (e.g., an insurance account number), member credentials (e.g., a membership number), transportation credentials (e.g., a transportation account number), loyalty credentials (e.g., a loyalty account number), payment credentials (e.g., a primary account number), event credentials (e.g., a ticket barcode), access credentials (e.g., a username and password, an access code), etc.

“Payment credentials” may include any suitable information associated with an account (e.g., a payment account and/or payment device associated with the account). Such information may be directly related to the account or may be derived from information related to the account. Examples of payment credentials may include a PAN (primary account number or “account number”), user name, expiration date, and verification values such as CW (card verification value), dCW (dynamic card verification value), CVV2 (card verification value 2), CVC3 card verification values, etc. An example of a PAN is a 16-digit number, such as “4147 0900 0000 1234.”

A “token” may be a substitute value for a credential. A token may be a string of numbers, letters, or any other suitable characters. Examples of tokens include payment tokens, access tokens, personal identification tokens, etc.

A “payment token” may include an identifier for a payment account that is a substitute for an account identifier, such as a primary account number (PAN). For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “restricted transaction” may include an interaction with a constraint. For example, a restricted transaction can be a transaction that adheres to one or more limits, rules, or controls. In some embodiments, a restricted transaction can be restricted based on a transaction location (e.g., in a zip code, in a building, at a service provider location, etc.), a transaction party (e.g., an approved service provider), a transaction time of day (e.g., business hours), a transaction day of the week (e.g., weekdays only or weekends only), a transaction value (e.g., up to $10, $25, $50, or $100), and/or any other suitable restriction. A restricted transaction can also be restricted based on the number of transactions thus far (e.g., in total or within a certain timeframe). For example, up to five transactions may be allowed, and any one of the first five transactions can qualify as a restricted transaction, but the sixth or more transaction may not qualify as a restricted transaction.

A “server computer” may be a powerful computer or combination of two or more computers. For example, the server computer can be a large mainframe, a minicomputer cluster, or a group of servers functioning as a unit such as a cluster. In one example, the server computer may be a database server coupled to a web server. Server computers often execute server applications that act as a server in client-server interactions, including but not limited to database server applications, web server applications, application server applications, etc.

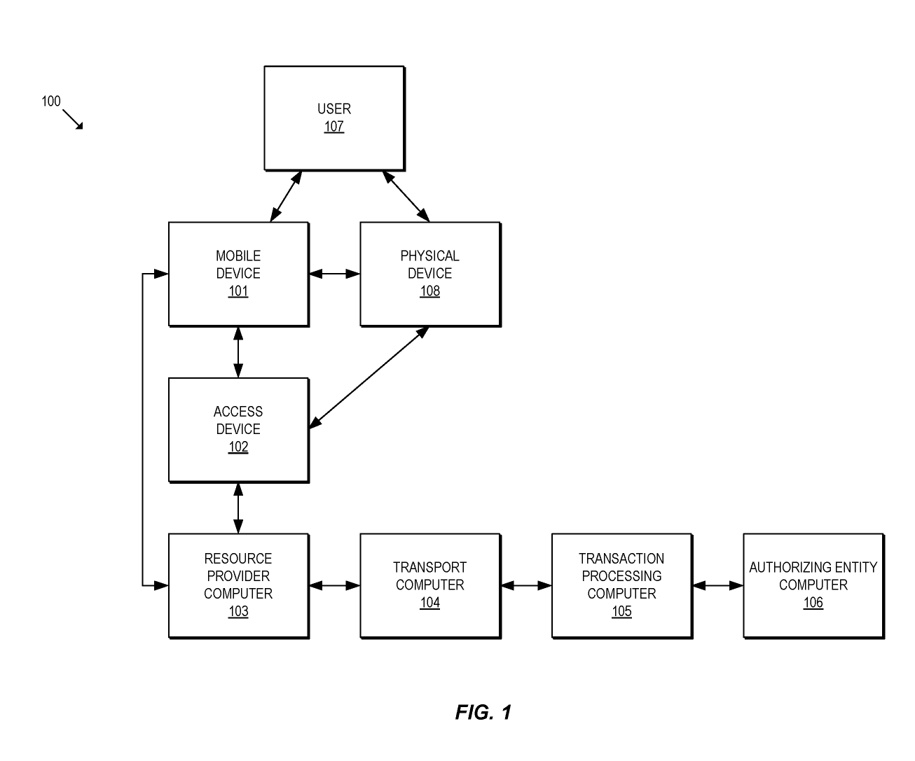

FIG. 1 illustrates a block diagram including entities in a transaction system 100. This depicted transaction system 100 includes a user 107, a physical device 108, a mobile device 101, an access device 102, a resource provider computer 103, a transport computer 104, a transaction processing computer 105, and an authorizing entity computer 106. The physical device 108, the mobile device 101, the access device 102, the resource provider computer 103, the transport computer 104, the transaction processing computer 105, and the authorizing entity computer 106 may all be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The user 107 can use the physical device 108 to conduct transactions with a resource provider associated with the resource provider computer 103. The physical device 108 can store information associated with the user 107 and/or an account. For example, the physical device 108 can store transaction credentials (e.g., payment credentials or access credentials) as well as personal information such as a name, address, email address, phone number, or any other suitable user 107 identification information. The physical device 108 can provide this information to the access device 102 during a transaction. In some embodiments, a physical device can 108 be a payment device (e.g., a credit card, debit card, etc.), an entry device (e.g., an access card or access badge), or any other suitable device for any suitable type of transaction.

The user 107 may also be able to use the mobile device 101 for conducting transactions with the resource provider. For example, the mobile device 101 can also store transaction credentials and any other suitable user 107 identification information, and the mobile device 101 can provide this information to the access device 102 during a transaction.

The resource provider computer 103 may be associated with a resource provider, which may be an entity that can provide a resource such as goods, services, information, and/or access. Examples of a resource provider include merchants, access devices, secure data access points, etc. A merchant may typically be an entity that engages in transactions and can sell goods or services, or provide access to goods or services. Another example of a resource provider is an access gate, which can provide access to a physical area. An additional example of a resource provider is a secure computer, which can provide access to a secure information. Another example of a resource provider is an airport security organization, which can provide access to a an airport.

The resource provider may accept multiple forms of payment (e.g., the physical device 108 and the mobile device 101) and may use multiple tools to conduct different types of transactions. For example, the resource provider may operate a physical store and use the access device 102 for in-person transactions. The resource provider may also sell goods and/or services via a website, and may accept payments over the Internet.

The transport computer 104 may be associated with an acquirer, which may typically be a business entity (e.g., a commercial bank) that has a business relationship with a particular merchant or other entity. Some entities can perform both issuer and acquirer functions. Some embodiments may encompass such single entity issuer-acquirers. The transport computer 104 may be more specifically referred to as an acquirer computer.

The transaction processing computer 105 may be disposed between the transport computer 104 and the authorizing entity computer 106. The transaction processing computer 105 may include data processing subsystems, networks, and operations used to support and deliver authorization services, exception file services, and clearing and settlement services. For example, the transaction processing computer 105 may comprise a server coupled to a network interface (e.g., by an external communication interface), and databases of information. The transaction processing computer 105 may be representative of a transaction processing network. An exemplary transaction processing network may include VisaNet™. Transaction processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The transaction processing computer 105 may use any suitable wired or wireless network, including the Internet.

Referring back to FIG. 1, the authorizing entity computer 106 may be associated with an authorizing entity, which may be an entity that authorizes a request. An example of an authorizing entity may be an issuer, which may typically refer to a business entity (e.g., a bank) that maintains an account for a user. An issuer may also issue and manage a payment account associated with the user device 108. Another example of an authorizing entity is a government entity that can issue and verify the authenticity of identity credentials. An additional example of an authorizing entity is an access server, which can issue and verify the authenticity of access credentials.

The transaction processing computer 105, the transport computer 104, and the authorizing entity computer 106 may operate suitable routing tables to route authorization request messages and/or authorization response messages using payment credentials, merchant identifiers, or other account identifiers.

Each of the entities (e.g., resource provider computer 103, transport computer 104, transaction processing computer 105, and authorizing entity computer 106) may comprise one or more computer apparatuses to enable communications or to perform one or more of the functions described herein.

In some embodiments, transaction system 100 is configured to process payment transactions. However, embodiments allow other types of transactions to be processed as well. For example, embodiments can be used for transactions systems that process identification transactions (e.g., prove identity with identity credentials), membership transactions (e.g., access membership benefits with member credentials), access transactions (e.g., access secure physical spaces or secure information with access credentials), loyalty transactions (e.g., use or gain loyalty points with loyalty credentials, etc.

In some scenarios, a user 107 with a mobile device 101 may desire to have the mobile device 101 be “provisioned” with credentials (e.g., credentials 207) for transactions. The credentials can be payment credentials to be used with merchants (e.g., with resource provider computer 103, typically via an application 208 such as a resource provider application 208A, web browser 208B, third-party application, etc.) or for other transactions. The credentials 207 may be for an account maintained by an authorizing entity 240. Thus, in some embodiments, mobile device 101 may need to be first provisioned with personalization data, such as payment information and information regarding a user 107.

As mentioned above, the mobile device 101 can also be provisioned with other types of credentials 207, such as identification card credentials, health insurance card credentials, member card credentials, transportation card credentials, loyalty card credentials, event ticket credentials, access badge credentials (e.g., an access code), secure data access credentials, etc.

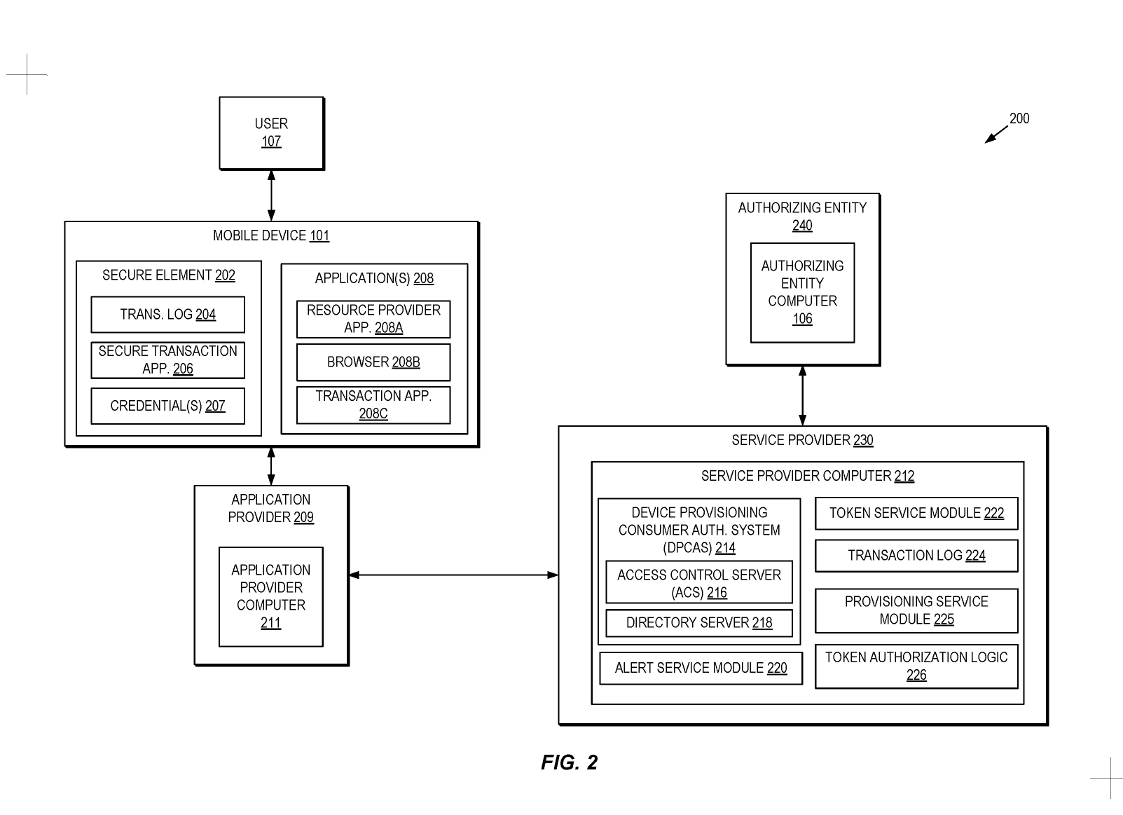

FIG. 2 shows an example of a system 200 that may be used to conduct device provisioning according to some embodiments of the invention. System 200 comprises mobile device 101, an application provider computer 211 associated with an application provider 209 (e.g., a wallet provider), a service provider computer 212 (e.g., a transaction processing computer 105) associated with a service provider 230 (e.g., a transaction processing network), and an authorizing entity computer 106 associated with an authorizing entity 240. Each of mobile device 101 and server computers 211, 212, and 106 may be implemented using one or more computing devices. In some embodiments, the mobile device 101 includes a secure element 202, which may be where the credentials 207 are provisioned to, and may optionally also include a secure transaction application 206 and/or a transaction log 204 (both of which may exist at mobile device 101 outside of secure element 202).

Application provider computer 211 may be a server computer or another computing device operated by or on behalf of an application provider 209. An application provider 209 may be any entity that provides an application (e.g., an application 208) to a user 107. One example of an application provider 209 may be a digital wallet provider (e.g., Visa Checkout™ or Google™ Wallet). A digital wallet provider may maintain digital wallets for users, each digital wallet comprising payment data for one or more payment accounts. An application provider 209 may be associated with an application installed on mobile device 101. For example, a Visa Checkout application on mobile device 101 may be configured to connect to an application provider computer 211 operated by Visa.

Service provider computer 212 may be a server computer or another computing device operated by or on behalf of a service provider 230. A service provider 230 may be any entity that provides provisioning or personalization services. For example, a service provider computer 212 may maintain a personalization database (not illustrated herein) with information about users, and may be configured to communicate with one or more authorizing entities 240 to determine personalized payment data for users 107. The service provider computer 212, via its provisioning service module 225, may provide “provisioning as a service” to one or more application provider computers 211, wherein the application provider computer 211 utilizes an application programming interface (API) to communicate with the service provider computer 212.

The service provider computer 212—such as a transaction processing computer 105—may, as part of its server computer(s) 212, provide a provisioning service module 225 and/or a device provisioning consumer authentication system (DPCAS) 214. The DPCAS 214 may operate as an authentication server that provides authentication services, and may include an access control server 216 (e.g., to determine whether an account is eligible for or participates in particular services) and/or a directory server 218 (e.g., that identifies, for an account, the associated authorizing entity 240 and/or ACS 216). In some embodiments, DPCAS 214 may verify user 107 authentication information, such as user-identifying information, one-time passwords, challenge-response information, etc. In other embodiments, parts or all of DPCAS 214 may be associated with (or provided by) an authorizing entity 240 or another entity. For example, in some embodiments, ACS 216 may be provided by authorizing entity computer 106. In some embodiments, DPCAS 214 is simply configured to determine an appropriate authentication system to be used for authentication, which may be implemented by the service provider computer 212, the authorizing entity computer 106, the application provider 211, or another third party.

The service provider computer 212 may additionally include token authorization logic 226. The token authorization logic 226 may be used to determine whether or not to authorize a transaction that includes a token as the payment instrument. For example, in some embodiments, a provisioned token can be partially active. A partially active token may be eligible for restricted transactions only. As a result, if a transaction conducted with the partially active token qualifies as a restricted transaction (e.g., the transaction obeys restrictions), the transaction can be approved. On the other hand, if a transaction conducted with the partially active token does not qualify as a restricted transaction (e.g., the transaction does not obey restrictions), the transaction can be declined.

For example, a partially active token may be usable for a specific subset of purchases, such as purchases that are less than a certain threshold amount (e.g., less than $500, $100, $50, or $10), purchases that take place at a certain place (e.g., at an approved merchant location, at an approved merchant type, at a certain address, or within a certain geographical area), or for a certain number of purchases (e.g., up to 1, 2, 3, 4, 5, 6, 7, 8, 9, or 10 transactions). The partially active token may be immediately usable upon provisioning, and then may be fully activated at a later time (e.g., after a user is authenticated).

Accordingly, the token authorization logic 226 may be used to enforce restrictions placed on partially active tokens that are still pending user authentication. For example, when a transaction is initiated, an authorization request message including the token and transaction details may pass through the service provider computer 212 (e.g., if the service provider computer 212 is the transaction processing computer 105). The service provider computer 212 may be able to detect whether the token is a partially active (e.g., pending verification) or fully active token. If the token is recognized as a partially active token, the service provider computer 212 may apply the token authorization logic 226 to determine whether the transaction should be forwarded to the authorizing entity computer 106 for authorization (or immediately authorized), or whether the transaction should be rejected. The authorization logic 226 may include any necessary information about whether a transaction with a partially active token should be approved. For example, the transaction details may include information about the transaction amount, when and where the transaction is taking place, the participating merchant and mobile device, etc. Some or all of this transaction data can trigger an authorization decision based on the authorization logic 226 (e.g., is the transaction for an approved amount, at an approved merchant, etc.).

In one example, a first user's mobile device receives a first provisioned token, and the first token is set as partially active. Before going through authentication to fully activate the first token (e.g., the first token is still pending), the first user immediately attempts to use the first token for a first purchase. The first purchase takes place at a first merchant and is for an amount of $600. An authorization request message arrives at the service provider computer 212 for the first transaction, and the service provider computer 212 rejects the first transaction, as the first token is not eligible for purchases over $100. However, the first user later goes through in an authentication process such that the first token becomes fully active. Having a fully active token, the same transaction is re-attempted and this time is successfully authorized, as the fully active token is not restricted to small purchases.

In another example, a second user's mobile device obtains a second provisioned token, and the second token is also set as partially active. Before going through authentication to fully activate the second token, the second user immediately attempts to use the second token for a second purchase. The second purchase takes place at a second merchant and is for an amount of $12. An authorization request message arrives at the service provider computer 212 for the second transaction, and the service provider computer 212 approves of the second transaction, as the second token is eligible for purchases under $100. Accordingly, the service provider computer 212 authorizes the transaction or forwards the authorization request message to the authorizing entity computer 106 for approval.

Additionally, the service provider computer 212 may provide additional services, including but not limited to an alert service 220 (e.g., via one or more processes executing at/by service provider computer 212) that can generate and provide alerts to a user 107 based upon transactions occurring with the user's 107 account. For example, alert service 220 may analyze one or more transactions of an account of user 107 using a set of one or more alert rules that may be configured by the user 107, and if any of the rules have conditions that are met (i.e., one or more rules are “triggered”), the alert service 220 may provide an alert message to the user 107 indicating and/or describing the triggering of the rules. As one example, a user 107 may configure a rule to be triggered (and thus, an alert message to be provided) when any transactions occur on their account having a value exceeding a defined threshold value. As another example, an alert message can be sent when any transaction occurs using a partially active token, or when a transaction is rejected based on a partially active token being used inappropriately.

The service provider computer 212 may also provide a token service module 222 that can generate and/or store a “token” (e.g., a first data value) that is associated with another, potentially sensitive second data value. For example, token service module 222, may generate a token value for a Primary Account Number (PAN) of an account, and provide the token value while keeping a stored association (or mapping) between the token value and the PAN, such that only the token service module 222 (or a limited set of entities) is able to “translate” the token value back to the actual PAN, providing enhanced security. Additionally, service provider computer 212—such as when it is operated by a transaction processing computer 105, may maintain/store a transaction log 224 of financial transactions that it processes.

In some embodiments, authorizing entity computer 106 may provide to service provider computer 212 personal information regarding users 107 associated with authorizing entity computer 106. For example, authorizing entity computer 106 may provide payment information, user information, account information, etc. In some embodiments, service provider computer 212 may provide to authorizing entity computer 106 data relating to the provisioning process. For example, if during a provisioning process a payment token was generated for a user's 107 account (e.g., by token service module 222), this payment token may be provided to the account's authorizing entity computer 106 by service provider computer 212.

Thus, in one use case of system 200, a user 107 may operate mobile device 101 to initiate a request for provisioning of a mobile application (e.g., a digital wallet application, which can be transaction application 208C and/or secure transaction application 206). The request for provisioning may be sent to application provider computer 211. Application provider computer 211 may forward the request to service provider computer 212, and in particular, to provisioning service module 225. The provisioning service module 225 may generate provisioning scripts (e.g., one or more of a partial personalization script, an activation script, a deletion script, etc.) using personalization data determined from authorizing entity computer 106 and/or one or more databases, and transmit these scripts to application provider computer 211. Application provider computer 211 may then initiate execution one or more of the scripts at mobile device 101. For example, application provider computer 211 may cause a partial personalization script to be executed by mobile device 101. At a same or different time, service provider computer 212 (e.g., provisioning service module 225) may authenticate the user, perhaps using its DPCAS 214. Once the partial provisioning script has been executed and the user 107 has been authenticated, provisioning service module 225 may instruct application provider computer 211 to cause an activation script to be executed on mobile device 101 to complete a provisioning, thereby completely an “installation” of a set of credentials 207 onto the mobile device 101 for use.

In various embodiments, the authentication processes are selectively utilized to avoid their use when additional authentication is not necessary but to efficiently incorporate them when additional authentication is helpful.

It should be noted that any of server computers 211, 212, and/or 106 may be operated by or otherwise associated with a same or different entity. For example, in one embodiment, service provider computer 212 may be operated by transaction processing computer 105, and in some embodiments, the DPCAS 214 may be operated by a third-party entity not illustrated herein or by authorizing entity computer 106, for example.

To assist in understanding the depicted entities of FIG. 2, an exemplary flow for provisioning credentials 207 (e.g., payment credentials) according to some embodiments is described.

A user 107 may send a request for provisioning by use of a mobile application 208 running on mobile device 101. For example, in a transaction application 208C (e.g., digital wallet application), the user 107 may request provisioning of an account, credit card, or any other payment credentials for mobile device 101. The request for provisioning message may include device information such as a mobile device 101 identifier, secure element 202 identifier, a secure element key identifier (or key), a user identifier (to identify a user or account), and user authentication information (e.g., a cryptogram such as a CVV2 for card verification based authentication processes, a ZIP code for geographic verification, etc.). The application provider computer 211 receives the request for provisioning message, and may perform a risk check or risk analysis for the requesting user 107, account, mobile device 101, or any other data that is present in the received request for provisioning message, or is tied to a user's account associated with the request for provisioning message. For example, the risk check may involve determining how many times the user's account has been provisioned and how many accounts are provisioned on mobile device 101. The risk check may, for example, indicate the likelihood that the request for provisioning is fraudulent. if the risk check indicates that the risk of provisioning is acceptable, then application provider computer 211 may send the request for provisioning to provisioning service module 225 executing at service provider computer 212. The request for provisioning message may include any of the information included in the message received from mobile device 101, and may include additional information determined by application provider computer 211, such as a primary account number (PAN) associated with the user's account and a reference number associated with the request for provisioning.

The provisioning service module 225 may then attempt to verify the provided user authentication information. For example, if the request for provisioning included a PAN and a cryptogram, provisioning service module 225 may retrieve a master encryption key, use the master encryption key to decrypt the cryptogram, and ensure that the decrypted value is an expected value (e.g., corresponding to received value of the PAN). The provisioning service module 225 may then generate a payment token to provision onto the mobile device using token service module 222. The payment token represents a PAN or other account number to be provisioned on the mobile device, and may comprise the actual PAN provided in the provisioning request, a generated token, the PAN together with a PAN sequence number, or another item of payment information to identify the account when used through the mobile transaction application 208C (e.g., a mobile payment application). The payment token may be included in the personalization data later stored onto the mobile device 101.

The provisioning service module 225 may then generate a partial personalization script, an activation script, and a deletion script, and send these “provisioning scripts” to application provider computer 211 in a provisioning script message. The partial personalization script (or “perso” script) may be operable to store personalization data onto mobile device 101, the activation script may be operable to activate or enable access to the personalization data, and the deletion script may be operable to delete or otherwise remove the personalization data from mobile device 101. The provisioning script message may also include device information (which may allow application provider computer 211 to identify which mobile device 101 is associated with the provisioning scripts), a reference identifier (for a similar purpose), and card art (which may be provided to mobile device 101 as a graphical representation of the account to be provisioned). In some embodiments, the provisioning scripts may be encrypted such that only mobile device 101 or the secure element 202 of mobile device 101 may decrypt the scripts. For example, the original request for provisioning sent by the mobile device 101 may include a public key (or a shared key) of the secure element 202 that allows other entities to use this public key to encrypt messages that can in turn only be decrypted by the secure element 202 using a corresponding private key.

When the provisioning script message is received by application provider computer 211, it may initiate execution of the partial personalization script on mobile device 101. The execution may be initiated by, for example, sending a partial personalization script message to mobile device 101 that comprises the partial personalization script and instructions (i.e., a command) to execute the script. Once received, a mobile application 208, secure element 202, or another suitable element in mobile device 101 may cause its processor to execute the partial personalization script.

In some embodiments, the partial personalization script may cause the mobile device 101 to store a token that is partially active. For example, the token may be immediately usable for a limited set or type of transactions, such as transactions below a certain threshold amount. The token may be fully activated at a later time, such as after the user 107 is authenticated.

The mobile device 101 may then send, to application provider computer 211, a partial personalization confirmation message indicating whether the partial personalization script was successfully installed, which may be forwarded to the provisioning service module 225 of the service provider computer 212.

At an earlier or later point in time, the provisioning service module 225 may utilize the DPCAS 214 to authenticate the user 107. For example, provisioning service module 225 may send an authentication request message to DPCAS 214. The authentication request message may include user authentication information provided by mobile device 101 or application provider computer 211, such as a PAN, and may also include a reference identifier and device information. The DPCAS 214 may then conduct a further risk assessment and authentication process and determine whether the user is authenticated and authorized to provision mobile device 101, which may include performing detailed checks such as whether the user's 107 account was previously flagged as compromised or an analysis of past transactions (e.g., using transaction log 224). Thus, DPCAS 214 may determine that the user 107 is authenticated, not authenticated, or may seek additional information from the user 107. For example, DPCAS 214 may cause an authentication request message to be sent to mobile device 101 requesting additional user authentication data, and then receive an authentication response message in return. Some examples of additional user authentication information may include answers to a challenge question, security question, a one-time password, etc. Eventually, the DPCAS 214 may provide an authentication response message back to the provisioning service module 225 to indicate a result of the authentication.

When provisioning service module 225, for example, has determined that it has received a partial personalization confirmation message and that it has made an authentication decision, the provisioning service module 225 may send an activation message or a deletion message to application provider computer 211. For example, provisioning service module 225 may send an activation message if the partial personalization confirmation message indicated a successful execution of the script and the authentication result indicates a successful authentication of the user. In some embodiments, such an activation message may be used to fully activate a previously provisioned token that is partially active, such that there are no longer restricted on the type of transactions for which the token can be used. Similarly, provisioning service module 225 may send a deletion message if either the partial personalization confirmation message or authentication result indicates a failure. The application provider computer 211, then, may initiate the execution of the activation script or the deletion script by the mobile device 101, depending on whether an activation message or deletion message was received, respectively. The initiation of the execution of the activation script/deletion script may be performed in a similar manner to initiation of the partial personalization script, as described above.

Upon the execution of the script, the mobile device 101 may then send a provisioning confirmation message to application provider computer 211 indicating whether the activation or deletion was successfully performed, and this message may be returned to the provisioning service module 225. With a successful verification that the account has been provisioned and activated on the device, service provider computer 212 may fully activate the account provisioned on the account by informing authorizing entity computer 106 of the activation. For example, if a payment token was previously generated for the payment account, provisioning service module 225 may send a token linkage message comprising the payment token and the account PAN to authorizing entity computer 106 instructing that the token and PAN to be linked.

As described earlier, typical account credential provisioning processes require multiple messages between the application provider computer 211 and a provisioning service module 225 (or service provider computer 212). Additionally, unnecessary delay is often encountered while user accounts are authenticated during provisioning, and thus there is a need to speed the process for provisioning payment accounts on mobile devices (e.g., using secure elements) and providing more efficient ways to provision large numbers of payment accounts on large numbers of mobile devices 101. Additionally, there is a need for enhanced authentication services during provisioning processes, as some legitimate consumers may have questionable initial authentication results, or may not be able to easily use typical authentication schemes. Accordingly, there is a need for additional authentication processes that do not interrupt or delay the provisioning process.

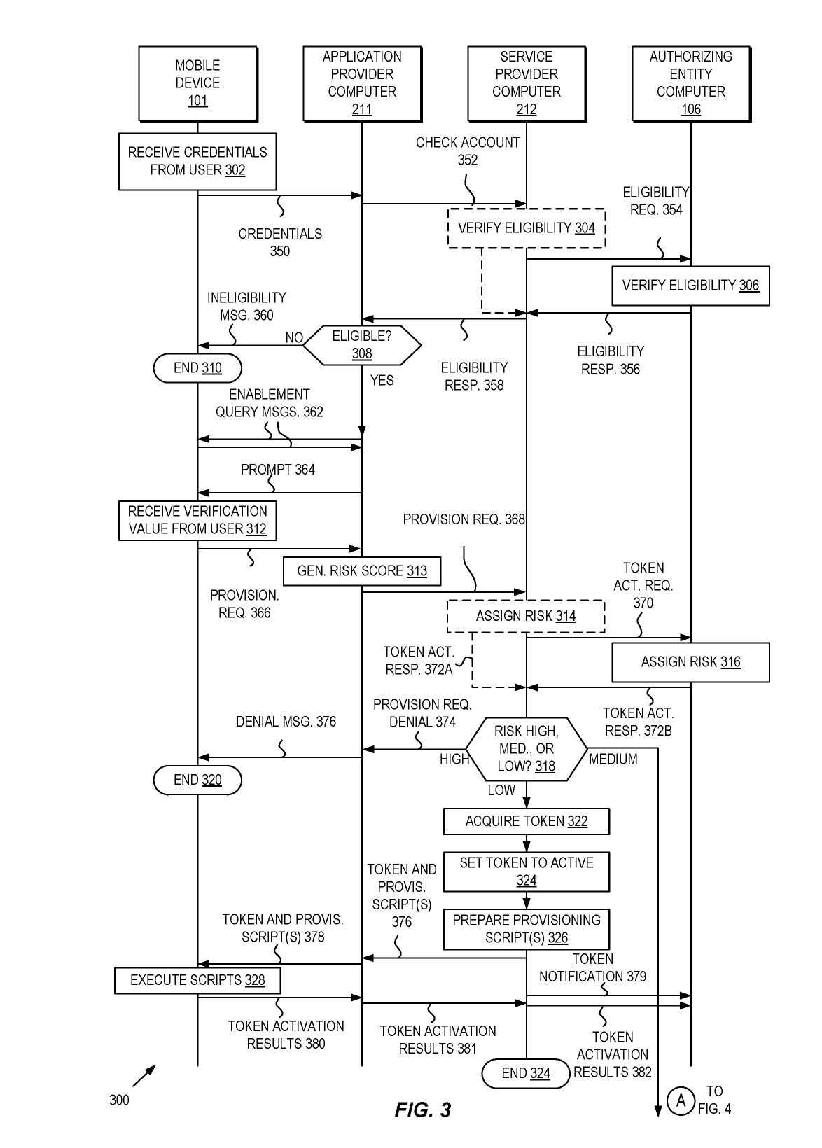

Embodiments of the invention address these problems, individually and collectively, through in part the use of differentiated risk-based provisioning. FIG. 3 illustrates a combined sequence and flow diagram 300 depicting account provisioning, including low risk and high risk provisioning, in an account provisioning system according to some embodiments of the present invention. As used herein, the terms “account provisioning”, “payment account provisioning”, “card provisioning”, “credential provisioning” and the like may be used interchangeably to refer to the process of putting (or “installing”) information associated with the user 107 and/or user account onto a mobile device 101 such that the mobile device 101 can utilize the account for performing a financial transaction, except where it is made clear from the usage of the term and/or its surrounding context that a difference is being referenced.

The depicted sequence and flow diagram 300 depicts messages sent between and actions performed by a set of entities. The set of entities includes a mobile device 101, application provider computer 211, service provider computer 212, and authorizing entity computer 106. In some embodiments, one or more computing devices (e.g., server computers) implement each of entities 211, 212, and 106. Thus, the actions and messages presented herein are described with reference to higher-level entities to provide ease of understanding. Additionally, in some embodiments more entities are involved in performing this set of actions, and in some embodiments fewer entities are utilized to perform this set of actions. Accordingly, this representation is merely illustrative of one possible embodiment and is not intended to be exhaustive or limiting.

The depicted process begins when initially user 107 logs into an electronic wallet application (e.g., transaction application 208C and/or secure transaction application 206) on their mobile device 101 at block 302 to initially request a provisioning of an account, credit card, or any other payment credentials for the mobile device 101.

However, in some embodiments, credentials 207 may be installed before the user even tries to activate, use, or otherwise provision the cards to the mobile device. Thus, the process described below may occur automatically without the user knowing. At some point, the user may request that the card credentials be provisioned on the mobile application, and at that time, no further data may need to be sent to the mobile device and the provisioned account may be nearly immediately accessible by the user. Accordingly, embodiments may complete a provisioning process for card credentials before a consumer even requests provisioning of a card instance on a mobile device. For example, a user 107 may download a mobile wallet application on their mobile device 101 and may enter their user name, identifier, cards registered, etc. At that time, the application provider computer 211 may initiate this described process for all of the cards registered with the mobile wallet. Accordingly, embodiments may apply provisioning scripts to user devices before a user even asks to provision a specific card.

However, upon the user 107 providing the credentials to the mobile device 101 at block 302, the mobile device 101 (e.g., at the request of a mobile transaction application) transmits the credentials 350 to the application provider computer 211. In the depicted embodiment, upon affirming that the credentials 350 are correct and for a valid account, will transmit a check account message 352 (e.g., make an API call for a card eligibility request) for one or more accounts of the user 107 to the service provider computer 212. In some embodiments, this check account message 352 includes one or more PANs of accounts of the user (or other types of account identifiers), which may have been provided by the user 107 (e.g., to the wallet provider) at an earlier time, or may have been provided by the user 107 along with the credentials (i.e., at block 302) and sent with the credentials message 350.

The service provider computer 212, for the PAN (or for one or more of the one or more PANs provided in, identified by, or otherwise associated with the check account message 352) verifies the eligibility of the associated account for which credentials are to be provisioned. In some embodiments, the service provider computer 212 verifies the eligibility at block 304, but in some embodiments the service provider computer 212 transmits an account eligibility request message 354 to the authorizing entity computer 106, and the authorizing entity computer 106 will then verify the eligibility at block 306 and return an account eligibility response message 356 indicating the eligibility of the account(s). In some embodiments, the account eligibility request message 354 may include a risk value indicating a risk associated with the request, as generated by the service provider computer 212 or application provider computer 211, which allows the authorizing entity computer 106 an additional factor to consider when verifying an eligibility of the request.

For example, for a particular PAN, block 304 may include identifying the authorizing entity computer 106 of the account (e.g., based upon a bank identification number (BIN) of the PAN, for example) and then determining whether that authorizing entity computer 106 allows for this provisioning to occur. Block 304 may also include utilizing a database of eligible and/or ineligible accounts (e.g., existing in an exception file listing those accounts that have been lost, stolen, or blocked), which may be provided by the authorizing entity computer 106. In some embodiments, this verification in block 304 may include performing a check digit calculation using the PAN based upon the issuer check digit scheme, determining whether the account has already been provisioned to a device (a same or different device), etc. Similarly, authorizing entity computer 106 may verify the eligibility of the account at block 306 according to a variety of ways left to configuration preference, such as allowing all accounts to have credentials be provisioned, allowing no accounts to have credentials be provisioned, or allowing only some accounts have credentials be provisioned—which may be based upon an account history, a history of the user's other accounts at the authorizing entity computer 106, whether the account has previously been provisioned, etc.

At some point, whether via block 304 or block 306, the service provider computer 212 will have determined the eligibility of the account(s), and will transmit an account eligibility response message 358 (e.g., send an API response message) to the application provider computer 211 identifying one or more accounts and indicating, for these accounts, whether the respective account is eligible for credential provisioning.

At block 308, if an account is not eligible, the application provider computer 211 may transmit an ineligibility message 360 to the mobile device 101, which may cause a message to be presented to the user 107 (e.g., via a display device) to indicate that the account is ineligible. Then, at block 310, the flow ends, and the user 107 may optionally attempt to begin the flow again for a different account.

If, at block 308, an account is eligible, the flow continues with the application provider computer 211 sending an enablement query message 362 indicating that the account is eligible, and the user 107 and/or wallet application may, in response, cause another enablement query response message 362 to be sent back to the application provider computer 211 to indicate that the user 107 does seek to “enable” the provisioning of the credential 207 associated with the account to the mobile device 101 (i.e., “add” their account to the mobile device 101). The enablement query message 362 may cause the mobile device 101 to also present a set of terms and conditions to the user during this service activation phase, which the user must accept to continue.

The application provider computer 211 then transmits a verification value prompt message 364 to the mobile device 101 seeking the entry of further card information (e.g., a verification value such as a CVV2 or CW value of a credit card, for example) of the account, which may cause the mobile device 101 to prompt the user 107 for this information. Upon receipt of this card information (e.g., a verification value such as a CVV2 value) from the user 107 at block 312, the mobile device 101 transmits a provision request message 366, which may include the provided card information value (e.g., CVV2 value).

The provisioning request message 366, in some embodiments, includes device information (to identify the mobile device 101 and secure element 202, and may include any unique identifier for the device to identify the secure element keys necessary), consumer identifier or login information/credentials (to identify the user 107), account credentials (e.g., a PAN and/or a card verification value (e.g., CVV2 for card verification based authentication processes)), and/or a zip code (for geographic based authentication processes). The provisioning request message 366 is sent by the mobile device 101 to application provider computer 211, which may generate a risk score (or perform a “risk check” or “risk analysis” to generate risk assessment data) at block 313 based upon the provisioning request message 366. This risk analysis may occur based upon the requesting user 107, account, card, mobile device 101, or any other data that is present in the provisioning request message 366 (e.g., a CVV2 value, ZIP Code, User Identifier, etc.) or is tied to the account of the user 107 submitting the provisioning request (e.g., previously registered/provisioned card data, determining how long the account has been open, how many cards the consumer uses in total or has used, a number of purchases in the past, etc.).

Assuming that the determined risk is not too high, the application provider computer 211 sends a provisioning request 368 to service provider computer 212 (e.g., provisioning service module 225). The provisioning request may include device information, a primary account number (PAN) associated with the account attempting to be provisioned, an expiration date, a user-entered CVV2 value, a ZIP code, a time-sensitive token (i.e., that can expire if a period of time passes) returned with the account eligibility response message 358, or any other information that may be associated with a user account, and a reference identifier for the provisioning request. The provisioning request 368 can also include a risk score.

In some embodiments, the provisioning request 368 may include a reference identifier (ID) of the PAN (or token) but not the PAN itself. This reference ID, in some embodiments, is preconfigured (or otherwise agreed upon) by both the application provider computer 211 and the service provider computer 212 so that both are aware of the mapping (or can otherwise translate) between the reference identifier and the PAN.

In some embodiments, the risk of the request is determined (or “assigned”) by the service provider computer 212 at block 314 (e.g., based upon rules and/or data provided by the authorizing entity computer 106 at an earlier time) to yield a token activation response 372A. However, in some embodiments the service provider computer 212 identifies the authorizing entity computer 106 of the account (e.g., based upon the PAN), transmits a token activation request message 370 (which may include a risk value indicating the service provider assigned risk 314 and/or a risk value generated by the application provider computer 211) to the authorizing entity computer 106 such that the authorizing entity computer 106, at block 316, will determine/assign its own risk and return a token activation response message 372B back to the service provider computer 212.

Similar to the verification of account eligibility described above with respect to blocks 304/306, the assignment of risk at block(s) 314/316 may be performed according to preferences of the implementing entities, and thus can be based upon a variety of factors including, but not limited to, whether the provided CVV2 value exists and is verified as correct, whether an earlier-provided token was included in the provisioning request 352, whether the requested account is already provisioned on the mobile device 101 or another device, if a provided address can be verified as correct, account configuration data provided earlier by the user 107, wallet provider data (e.g., a risk value), device information such as its available hardware or software capabilities, fingerprint or other identifier, etc.

In some embodiments, the service provider computer 212, after sending the token activation request message 370, may be configured to only wait for the corresponding token activation response message 372B for a period of time. In some of these embodiments, if the period of time expires, the service provider computer 212 may use its own generated risk assignment 314 outcome (i.e., a token activation response 372A) to continue the flow, and may optionally (not illustrated) transmit another message to the authorizing entity computer 106 to identify what risk assignment 314 outcome it assigned and/or how the service provider computer 212 chose to proceed. This embodiment allows the process to continue proceeding an efficient, highly-responsive manner to avoid keeping the user 107 waiting.

Regardless of the exact risk assignment formulation of blocks 314/316, the token activation response message 372A/372B may indicate a level of risk. In some embodiments, at least three levels of risk may be generated, including a “low” risk where the provisioning request is unconditionally approved, a “medium” risk where the provisioning request is conditionally approved, and a “high” risk where the provisioning request is declined. The depicted flow varies based upon which of these levels of risk were generated.

At block 318, the service provider computer 212 determines which level of risk was determined. As depicted, block 318 indicates identifying whether the level of risk was “High,” “Medium,” or “Low.” Of course, although in some embodiments the levels of risk may be explicitly categorical (and thus uniquely identify which risk category is determined), in other embodiments the levels of risk may be in other formats (e.g., a risk score is generated that is an integer between 0 and 100, for example, and thus the determination of the risk category may include determining if the risk score is within a range of values, meets or exceeds a value, is below a value, etc.).

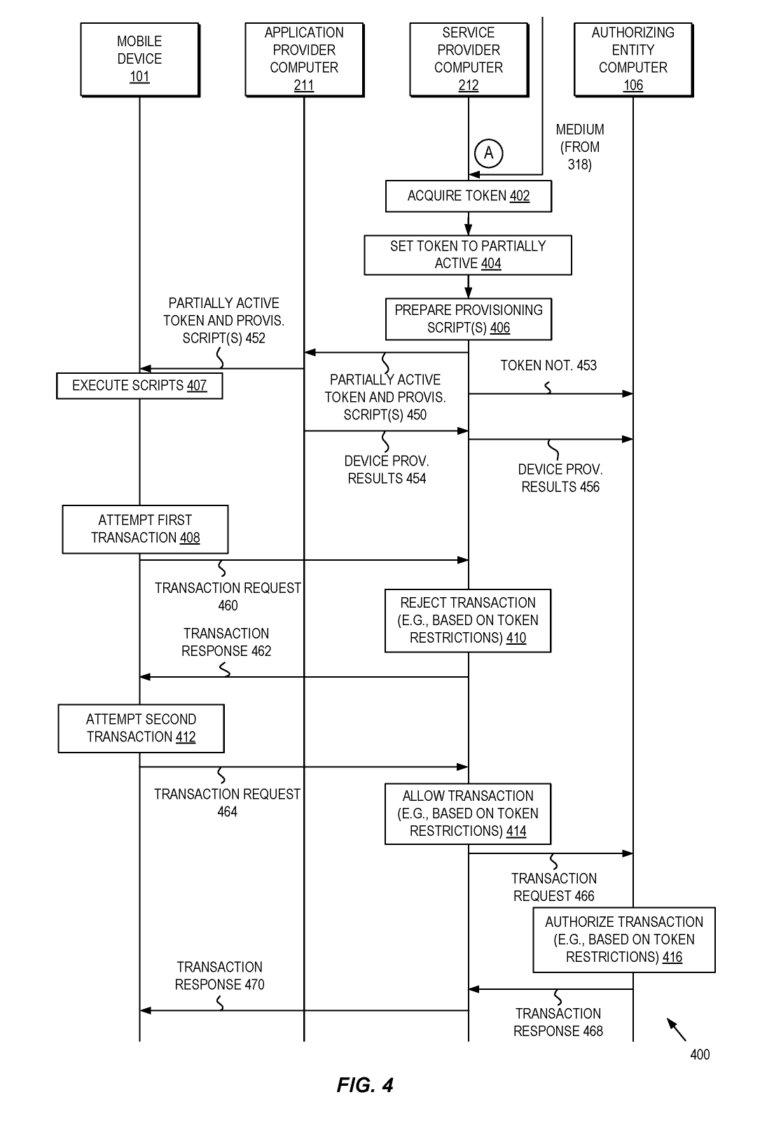

FIG. 3 depicts how flow continues for the “high” and “low” risk levels, and FIG. 4 illustrates how flow continues for “medium” risk levels, as indicated by the line leading to the bottom of the page and labeled “TO FIG. 4” next to circle ‘A’.

If, at block 318, the risk level is identified as “high,” the service provider computer 212 may transmit a provision request denial message 374 indicating that the provision request message 368 is denied. In response, the application provider computer 211 may transmit a denial message 376 to the mobile device 101, which presents a message to the user 107 indicating the denial and/or instructing the user 107 to contact the issuer of the account (e.g., to ask the issuer to enable the account for account provisioning). At this point, the “high risk” flow ends at block 320.

If, at block 318, the risk level is identified as “low,” the service provider computer 212 may acquire a token 322. In an embodiment, this token acquisition 322 includes the provisioning service module 225 requesting, from token service module 222 (which may be a part of service provider computer 212—as illustrated—or part of another device), a token for a PAN by sending the PAN to the token service module 222. The token service module 222 may then, using a variety of transformation techniques, generate and return a token, and may store a mapping between the token and the PAN for future translations. For example, in an embodiment, the token may be created with a same size as the PAN (e.g., having a same number of digits), have a same BIN value (or another BIN value within a range of associated BIN values) as the PAN, etc. The token service module 222 (and/or the provisioning service module 225) may store a sequence number (e.g., 0 for a first time token creation for the PAN) of the token, an expiration date of the token (e.g., to be 24 or 36 months from the request date, for example), and set the token to be an “active” token at block 324, perhaps by setting a value within its records, or perhaps by modifying the token value itself.

At block 326, the provisioning service module 225 prepares and sends a message 376 to the application provider computer 211 including the token (received from the token service module 222) along with a set of one or more provisioning scripts. In some embodiments, the this message 376 includes one or more of the token (which may be encrypted), a token expiration date, a portion of the associated PAN (e.g., the last four digits), a portion of the token itself (e.g., the last four unencrypted digits), the associated card metadata, a token reference identifier, a PAN reference identifier, a token to be returned with further messages, and/or the personalization scripts. Then, the application provider computer 211 may forward, in another message 378 back to the mobile device 101, some or all of the information from message 376 (e.g., the provisioning scripts and the token, for example) to cause the token for the account to be provisioned onto the mobile device 101 (by executing the scripts at block 328). In some embodiments, the set of provisioning scripts includes a partial personalization script and an activation script, although in some embodiments the functionality provided by the partial personalization script and the activation script is consolidated into one (or more) scripts.

At block 379, the service provider computer 212 may transmit a token notification message 379 to the authorizing entity computer 106 that includes some or all of the information from the message 376, including but not limited to the token, token expiration, a portion or all of the PAN, etc., which serves to notify the authorizing entity computer 106 of the generated token.

Upon execution of the provisioning scripts received by the mobile device 101 in message 378, the mobile device 101 may return a token activation results message 380 to the application provider computer 211 (e.g., the wallet provider) to confirm and/or deny whether the token (i.e., credential 207) was successfully provisioned (i.e., installed). This message 380 may be forwarded on by the application provider computer 211 to the service provider computer 212 in token activation results message 381, which may further forward the message on as message 382 to the authorizing entity computer 106. At block 324, the “low” risk flow ends.

Going back to block 318, if the assigned risk value is deemed to be “medium” risk, flow continues to the bottom of the figure and leads to FIG. 4. FIG. 4 illustrates a combined sequence and flow diagram 400 depicting medium risk account provisioning in an account provisioning system with respect to FIG. 2 according to some embodiments of the present invention.

Circle ‘A’ indicates a beginning to the “medium” risk flow, and the service provider computer 212 acquires a token at block 402 in a similar manner to the token acquisition described above with respect to block 322 in the “low” risk flow. Accordingly, the service provider computer 212 may generate a token, retrieve a stored token, or ask another entity for a token (e.g., a third party token provider service).

At block 404, the token is set to partially active, which may include modifying the token (e.g., changing the last one to four digits to a value that indicates a partially active token), and/or modifying a provisioning script to cause the token to be placed as partially active (i.e., available for restricted use by the mobile device 101 for the present time), such as by setting a flag within a memory location of the mobile device 101 (e.g., setting a protection flag within a memory of a secure element 202), etc.

In some embodiments, as described above, when a partially active token is installed at the mobile device 101, the token can be flagged as a token with limited activity, or otherwise installed such that it is only useable for a limited set of transactions. Alternatively, the partially active token can be installed in a similar manner as an active token, and the mobile device 101 may allow the partially active token to be used for any transaction. In this scenario, the token can be labeled as partially active at the backend (e.g., at the application provider computer 211, the service provider computer 212, or the authorizing entity computer 106). For example, the service provider computer 212 may store a credential record (or a token record), and the credential record can indicate that the token stored at the mobile device 101 is partially active (e.g., the version of the token stored on the mobile device 101 is associated with a partially active state at the backend server). As a result, the partially active token may only be authorized at the backend (e.g., by the service provider computer 212) for certain restricted purchases, and the partially active token may be denied (e.g., by the service provider computer 212) when used for other purchases.

At block 406, the service provider computer 212 prepares one or more provisioning scripts, which in some embodiments includes personalization scripts but not activation scripts. In some embodiments, the provisioning scripts can also include partial-activation scripts, but not full-activation scripts. In other embodiments, as mentioned above, the provisioning scripts can include full-activation scripts (e.g., partial activation can be managed at the service provider computer 212 instead of the mobile device 101).

The provisioning scripts and the partially active token are sent in a message 450 to the application provider computer 211. The message 450 may include some or all of the items as described with respect to message 376 in the “low” risk flow of FIG. 3, and in particular, may include an indicator that the token is partially active (e.g. marked as “pending” verification but limited activity allowed) and/or that the application provider computer 211 is to acquire a dynamic verification value delivery choice from the user 107 (described later herein). The provisioning scripts and the partially active token are then forwarded on by application provider computer 211 in a message to the mobile device 101, where the scripts are executed at block 407 to cause the partially active token to be installed.

In some embodiments, a partially active token can be immediately usable for certain types of restricted transactions, before the user is authenticated and the token fully activated. The token can be used for purchases at certain trusted merchants, for purchases within a certain geographical area, for a certain number of purchases (e.g., no more than 1, 5, or 10 purchases), for purchases that are less than a certain pre-defined amount (e.g., less than $100, $25, $10, etc.), for in-person purchases only, for over-the-internet purchases only, for any combination of these restrictions, or for any other suitable purchase that may have a relatively low risk.

The use of the partially activated token can be restricted until the user is authorized and the token is fully activated. Once fully activated, the restrictions can be lifted. For example, a fully activated token can be used and processed as a normal token. In some embodiments, a fully activated token can still be rejected based on the certain transaction scenario (e.g., transactions greater than $5000, multiple transaction in rapid succession, a transaction in an unusual geographical area or at an unusual merchant, etc.). However, the rejection may be based on normal risk analysis, and not based on a restricted status.

Similar to message 379, the service provider computer 212 may transmit a token notification message 453 to the authorizing entity computer 106 to inform the authorizing entity computer 106 of the generated token and its mapping to the PAN.

In some embodiments, the mobile device 101 transmits (not illustrated) a message to the application provider computer 211 to indicate whether the installation of the partially active token was a success, and in response, the application provider computer 211 will transmit a device provisioning results message 454 back to service provider computer 212, which in turn may forward the device provisioning results message 454 as message 456 back to the authorizing entity computer 106.

With the partially active token provisioned, the mobile device 101 can then be used for a restricted set of transactions. Two transaction scenarios will now be described. However, embodiments allow any suitable number of transactions to take place before the user is authenticated and the token fully activated.

At block 408, the user can attempt to use the partially active token for a first transaction. For example, the user can select one or more goods or services from a merchant and present the mobile device 101 as a payment instrument to an access device. The mobile device 101 can transmit the token (e.g., through contact or contactless communication) to the access device, and the merchant (e.g., via the access device or a merchant computer) can send an authorization request message for the transaction. The authorization request message can include the partially active token and information about the transaction, such as the amount and items being purchased. The authorization request message can be sent to a transport computer, which can forward the authorization request message to the service provider computer 212. While some of these entities are not shown in FIG. 4, the various steps for sending and forwarding the authorization request message to the service provider computer 212 are represented by the transaction request 460.

At block 410, the service provider computer 212 receives the authorization request message and determines whether to authorize the first transaction or forward the authorization request message to the authorizing entity computer 106. The service provider computer 212 can determine that the received token is a partially active token. For example, the service provider computer 212 can look up and identify a record associated with the token (e.g., a credential record) based on the token received in the authorization request message. The credential record can indicate that the token is partially active. The service provider computer 212 can also identify a flag included in the authorization request message, the flag indicating the token is partially active. The service provider computer 212 can also recognize a certain format or string of digits in the token indicating that the token is partially active.

The service provider computer 212 can then determine whether the first transaction is within a set of restrictions associated with the partially active token. In some embodiments, all partially active tokens can have the same set of restrictions. Alternatively, the service provider computer 212 can look up a set of restrictions specifically associated with this token.

The service provider computer 212 can compare the transaction parameters (e.g., the amount, the goods or services being purchased, the merchant name or location, a geolocation, etc.) with the restrictions set on the partially active token. If the transaction parameters exceed the token restrictions, the first transaction can be rejected. In this example, the first transaction is rejected by the service provider computer 212. For example, the transaction may exceed a value limit, exceed a number of allowed transactions, violate a time-of-day or day-of-the-week restriction, violate a transaction velocity limit, or otherwise exceed restrictions on the partially active token.

The service provider computer 212 can then send an authorization response message back to the access device (e.g., via the transport computer and/or merchant computer) indicating that the first transaction is rejected (as shown by the transaction response 462 in FIG. 4).

In other embodiments, the mobile device 101 can reject the first transaction before it is initiated. For example, the mobile device 101 can determine that a restriction is being breached (e.g., a time of day restriction, velocity restriction, number of transactions restriction, etc.) and disable a function for transmitting the token to the access device. In further embodiments, the service provider computer 212 can forward the authorization request message to the authorizing entity computer 106, and the authorizing entity computer 106 can make the determination of whether or not to reject the first transaction.

At block 412, the user can attempt to use the partially active token for a second transaction. For example, the user can select one or more goods or services from a merchant and present the mobile device 101 as a payment instrument to an access device. The mobile device 101 can transmit the token (e.g., through contact or contactless communication) to the access device, and the merchant (e.g., via the access device or a merchant computer) can send an authorization request message for the transaction. The authorization request message can include the partially active token and information about the transaction, such as the amount and items being purchased. The authorization request message can be sent to a transport computer, which can forward the authorization request message to the service provider computer 212. While some of these entities are not shown in FIG. 4, these messages are represented by the transaction request 464.

At block 414, the service provider computer 212 receives the authorization request message and determines whether to authorize the second transaction or forward the authorization request message to the authorizing entity computer 106. The service provider computer 212 can determine that the received token is a partially active token. For example, the service provider computer 212 can look up and identify a record associated with the token (e.g., a credential record) based on the token received in the authorization request message. The credential record can indicate that the token is partially active. The service provider computer 212 can also identify a flag included in the authorization request message, the flag indicating the token is partially active. The service provider computer 212 can also recognize a certain format or string of digits in the token indicating that the token is partially active.

The service provider computer 212 can then determine whether the second transaction is within a set of restrictions associated with the partially active token. In some embodiments, all partially active tokens can have the same set of restrictions. Alternatively, the service provider computer 212 can look up a set of restriction specifically associated with this token.

The service provider computer 212 can compare the transaction parameters (e.g., the amount, the goods or services being purchased, the merchant name or location, a geolocation, etc.) with the restrictions set on the partially active token. If the transaction parameters exceed the token restrictions, the second transaction can be rejected. In this example, the second transaction is allowed by the service provider computer 212. For example, the transaction may not exceed any limitations associated with the partially active token.

The service provider computer 212 can then de-tokenize the token to obtain the associated payment credentials. This can include determining a set of payment credentials associated with the token in a token database, or requesting payment credentials associated with the token from a third party computer. The service provider computer 212 can then add the payment credentials to the authorization request message, and then forward the authorization request message to the authorizing entity computer 106 (as shown by the transaction request 466). The service provider computer 212 can also optionally remove the token from the authorization request message before forwarding.

At block 416, the authorizing entity computer 106 can determine whether or not to authorize the second transaction. In some embodiments, the authorizing entity computer 106 can compare the transaction parameters with restrictions placed on the partially active token. The authorizing entity computer 106 can also perform other risk processing activities (e.g., check whether an account associated with the payment credentials has sufficient funds for the transaction).

The authorizing entity computer 106 then sends an authorization request message back to the service provider computer 212 (as shown by the transaction response 468), the authorization request message indicating that the transaction is authorized. The service provider computer 212 can forward the authorization response message back to the access device (e.g., via the transport computer and/or merchant computer) as shown by the transaction response 470. The merchant can then release the purchases goods or services to the user.

Thus, the user can immediately use a token even if the user has not yet been authenticated, improving efficiency and user experience. Security is maintained by limiting the use of the partially active token. For example, if a fraudster requested the token illegitimately, the fraudster's purchases can be limited in value, number, and scope. Thus, any possible damage is limited and controlled. The fraudster can be detected when he fails authentication (described below), and the partially active token can be deleted or deactivated.

As mentioned above, embodiments of the invention apply to any suitable type of credential that can be provisioned in a partially active state onto a mobile device. Other types of provisioned credentials can have different types of restrictions when partially active. For example, a partially active identification card credential may allow the user to board a plane, but not to open a bank account. A partially active health insurance card credential may allow a user to schedule an appointment, but not access personal health history files. A partially active member card credential may allow a user to exercise some membership privileges (e.g., access a members-only room), but not make charges to a membership tab or account. A partially active transportation card credential may allow a user to take a limited amount of rides (e.g., up to 3, 4, or 5 rides) or short rides (e.g., local transportation), but not unlimited rides or long-distance rides. A partially active loyalty card credential may allow a user to accrue loyalty points, but not use loyalty points. A partially active event ticket credential may allow a user to enter a stadium, but not access seat or private room. A partially active access badge credential (e.g., an access code) may grant access to a low-security area of a building (e.g., enter a front door), but not a high-security area of a building (e.g., an office, a room with sensitive information, etc.). A partially active secure data access credential may allow a user to access some information or functionality (e.g., view recent emails in an email account), but not access other information or functionality (e.g., view all emails or write emails from an email account).

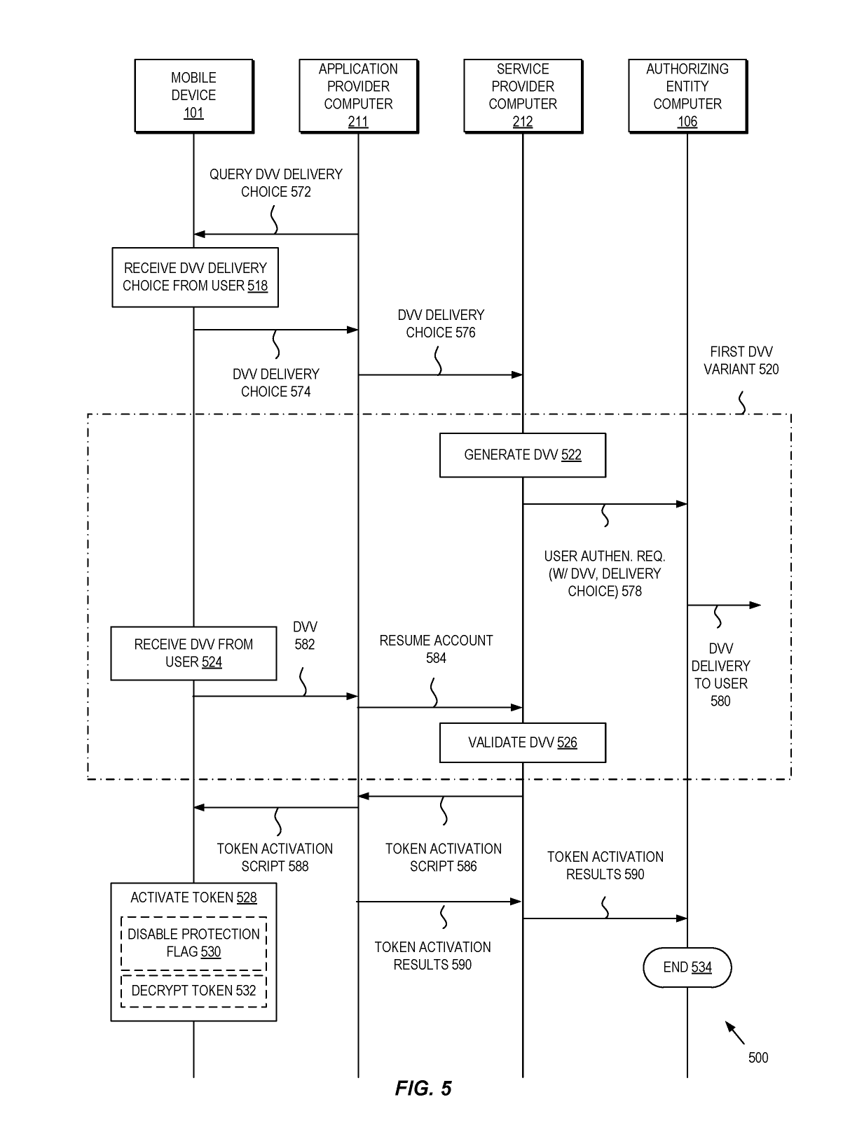

After the above-described example transactions, the flow continues in FIG. 5. FIG. 5 illustrates a combined sequence and flow diagram 500 depicting token verification for full activation in an account provisioning system with respect to FIG. 2 according to some embodiments of the present invention.

At this point, the application provider computer 211, based upon the indicator that the token is partially active and/or that the application provider computer 211 is to acquire a dynamic verification value delivery choice from the user 107 (from message 450), will send a query message 572 to seek the user's selection as to a preferred way for the user to receive a dynamic verification value (DVV). In some embodiments, this DVV serves as an element of an additional (or “stepped-up”) user verification procedure that can be used to increase the confidence that an ultimate provisioning of a credential is proper and thus, is much less likely to be fraudulent. In these examples, a DVV that is a one-time password is discussed; however, many other verification methods may be employed, including but not limited to performing a challenge/response test with the user via mobile device 101 (e.g., based upon information the legitimate user previously provided or is likely to know), having the user call a telephone number (of a customer service center of the issuer, as one example) to pass a set of challenge/response tests, having the user click on a link within an email sent to an email address on file for the user, having the user submit a voice sample or other biometric sample (e.g., fingerprint impression, iris scan, facial image, etc.) for recognition, or another known authentication technique.

As an example, a set of delivery options for the DVV may be presented to the user, including but not limited to receipt through the mobile transaction application (e.g., a mobile payment application), receipt of a text message (e.g., Short Message Service (SMS) or other similar messaging service message), placing or receiving a telephone call to acquire the DVV (e.g., to a call center), receipt of the DVV within an email sent to an email address on file for the user, etc. The user 107 may select one of these options and thus the mobile device 101 will receipt the user's selected DVV delivery choice at block 618, and transmit a message 574 including the selected delivery choice to the application provider computer 211, which will forward the delivery choice on in another message 576 (e.g., in a “send OTP” message) to the service provider computer 212. Further, some or all of the delivery options may include obfuscated information, such as a partially hidden/obscured telephone number (alongside one or more erroneous telephone numbers) or email address, for example.

The service provider computer 212, in some embodiments, will verify the message 576 by performing one or more of verifying whether a token reference ID passed in the request is valid, whether a token-to-PAN mapping is known to exist, whether that token has previously been provisioned, whether the token is currently in a partially active state, whether a maximum number of OTP code attempts (as allowed by the issuer) has been met or exceeded, etc.

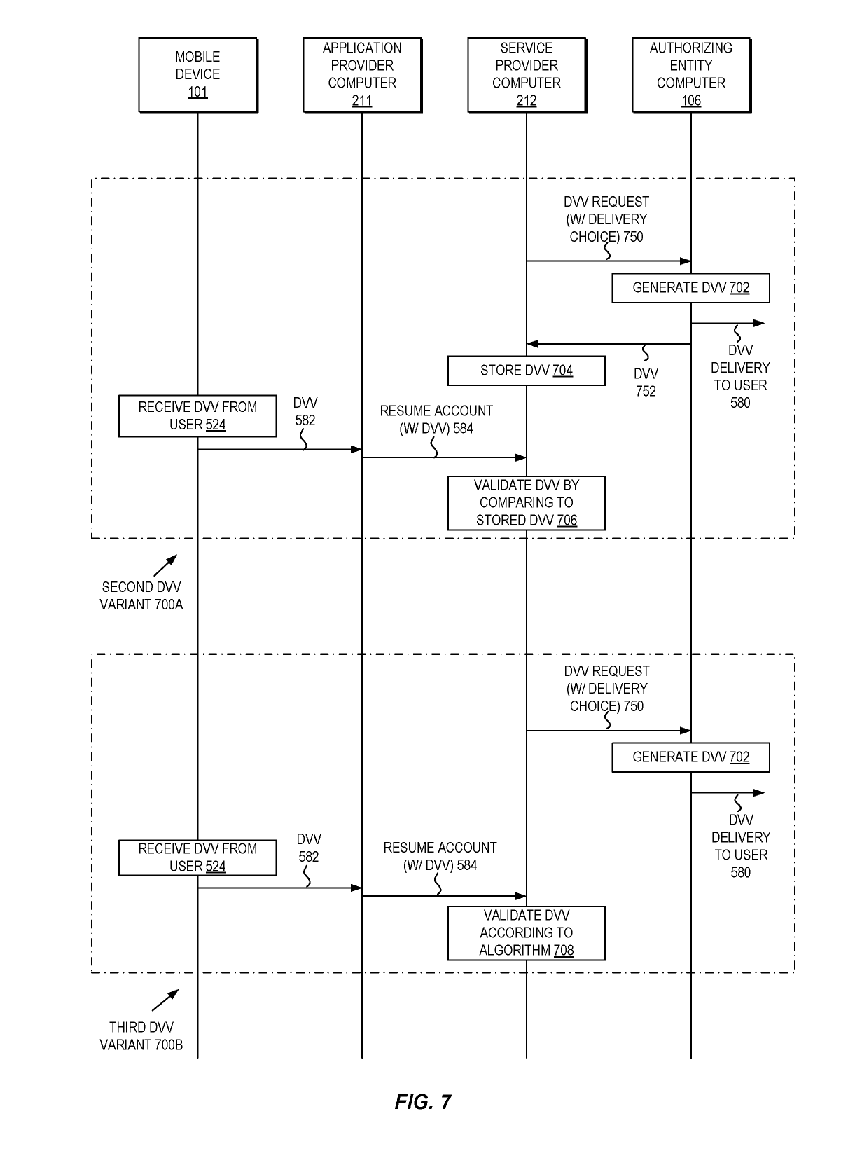

At this point, several configurations exist for generating and/or validating an entry of a DVV. A first DVV variant 520 is illustrated here in FIG. 5, although two other variations are presented later herein in FIG. 7. However, in the first DVV variant 520, the service provider computer 212 will generate a DVV at block 522, which may include generating a length of random characters/numbers/values. For example, in an embodiment a DVV is a randomly generated four digit number. The generation at block 522 may further include setting an expiration date/time for the generated DVV, and/or setting a “retry count” indicating how many times the user may attempt to provide the DVV, both of which may be sent and/or stored.

In this first variant 520, the service provider computer 212 transmits a user authentication request message 578 (including the user-selected DVV delivery choice and the generated DVV) to the authorizing entity computer 106. In some embodiments, if the authorizing entity computer 106 does not respond with a consumer authentication response message within a configured timeout period of time, the service provider computer 212 may transmit an error message to the application provider computer 211 indicating that the application provider computer 211 should send another message (e.g., another message 576) after a particular amount of time.

After receipt of the user authentication request message 578, the authorizing entity computer 106 contacts the user 107 via the selected delivery choice mechanism (see message 580) to provide the user 107 with the generated DVV. Thus, the selected delivery choice mechanism may be thought of utilizing a second “channel” of communication with the user (e.g., via SMS or email), as opposed to the first “channel” from the user's mobile device 101 through the application provider computer 211 to the service provider computer 212.

At some point, the DVV is provided to the user 107 according to the selected delivery mechanism, and the user may input the DVV into the mobile device 101 (e.g., via the mobile wallet application), which receives the entry of the DVV at block 524, and transmits the DVV in a DVV message 582 to the application provider computer 211. Alternatively, a clickable verification link can be sent to the user 107, and when the user 107 clicks the link, the DVV (or other verification message) can be sent to the application provider computer 211 or service provider computer 212.

At this point, the application provider computer 211 may transmit a Resume Account message 584, which includes the entered-DVV (from message 582) along with an identifier of the respective account (e.g., a PAN, a reference ID, the partially active token, etc.). The service provider computer 212 may verify the Resume Account message 584 by performing one or more of the following: verifying whether a token reference ID in the message 584 is valid, whether a token-to-PAN mapping is known, whether the token has previously been issued to the application provider computer 211, whether the token is in the partially active state, etc.

At block 526, the service provider computer 212 then validates the DVV based upon a stored copy of the DVV (from when it was generated in block 522) or by generating a copy of the DVV (e.g., in an embodiment where the DVV is generated based upon a defined and can be re-generated). In some embodiments, the service provider computer 212 also verifies that the DVV has not expired based upon its submission time and/or verifies the number of user attempts to submit the DVV does not exceed a configured allowable number of attempts.

If, at block 526, the DW is not validated, there are several (not illustrated) options for proceeding depending upon the needs of the system implementer. In some embodiments, one of the DVV variants (e.g., first DVV variant 520) may be performed one or more additional times until the DVV is validated or a number of attempts has been satisfied. In other embodiments, the service provider computer 212 simply transmits an error code to the application provider computer 211.

However, when (at block 526) the DVV is validated, the service provider computer 212 may update its records to indicate that the token is now fully active (e.g., update a status maintained by token service module 222 for the token), and may generate and/or provide an activation script to the application provider computer 211 in message 586, which is forwarded to the mobile device 101 as message 588. The mobile device 101 may then fully activate the token at block 528 by executing the token activation script, which may cause a protection flag of the token (e.g., within secure element 102) to be disabled (at block 530), or may restore a previously-modified token (at block 532). In some embodiments, the mobile device 101 reports back to the application provider computer 211 an indicator of whether the token activation was successful (not pictured, and may include an identifier of the account/token and a yes/no or other description of the success or lack thereof of the token activation), and the application provider computer 211 then transmits the token activation results message 590 to the service provider computer 212, which may forward the results on to the authorizing entity computer 106. At this point, the “medium” flow terminates at block 534.

In some embodiments, once the activation script is sent to the mobile device 101, the token may then be fully activated, such that previous transaction constraints (e.g., blocking of purchases above a certain threshold) may be lifted.

In some embodiments, an activation script may not be necessary as a partially active token may not be limited at the mobile device 101. Instead, the application provider computer 211 (or other backend server) may remove transaction constraints at a server computer in order fully activate the token, such that transactions outside the previous constraints are no longer blocked during authorization processing. For example, a credential record at the service provider computer 212 can be updated to indicate that the token stored at the mobile device 101 is now associated with a fully active state, and no longer associated with a partially active state. In this case, the message 588 may not include the activation script, but may still be sent to inform the mobile device 101 that the restrictions were lifted.

In other embodiments, the partially activated token may not be fully activated (e.g., restrictions may not be withdrawn at the mobile device 101 or the backend servers). Instead, the first token (e.g., the partially activated token) can be temporary token. Once the user is authenticated, the temporary first token can be deleted or de-activated at the mobile device 101, the service provider computer 212, and/or authorizing entity computer 106. Then, a second token can be provisioned to the mobile device 101. This second token can be a fully activated token. In this case, records at the service provider computer 212 and authorizing entity computer 106 can be updated such that the PAN (or other credentials) are associated with the second token and/or no longer associated with the first token.

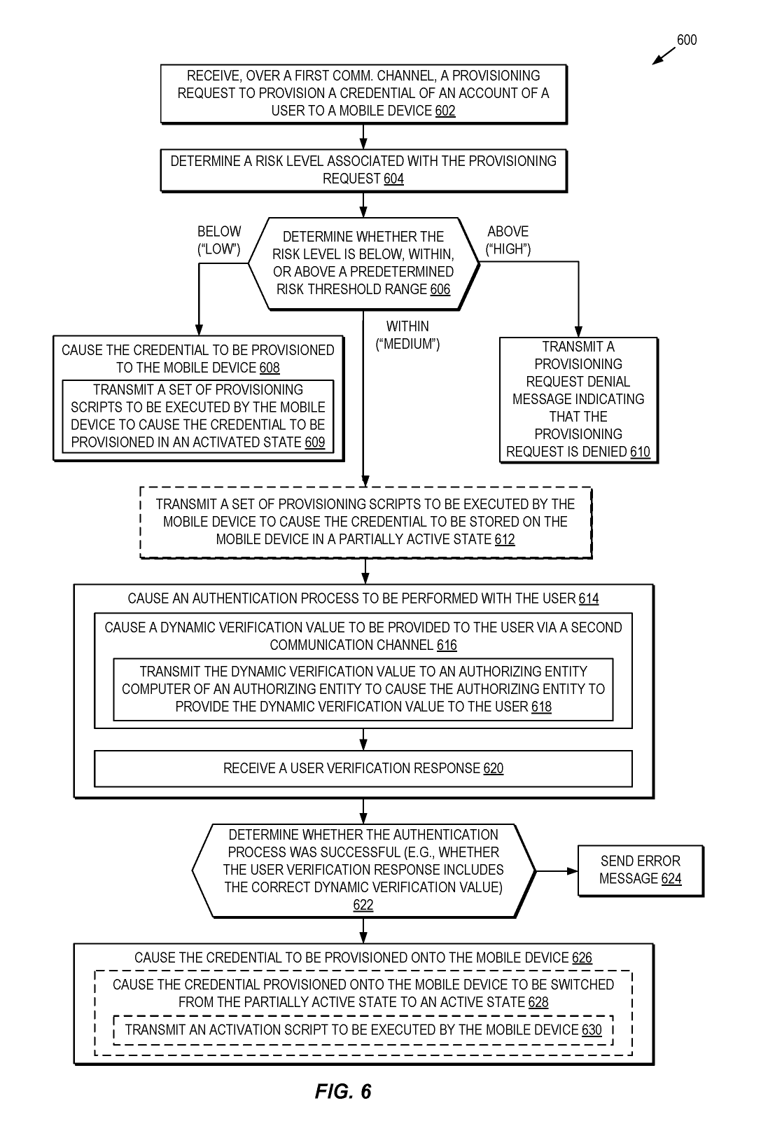

FIG. 6 illustrates a flow 600 in a server computer for account provisioning according to some embodiments of the present invention. In some embodiments, the operations of flow 600 may be performed by a service provider computer 212, and in some embodiments the operations of flow 600 are performed by provisioning service module 225.

Flow 600 includes, at block 602, receiving, over a first communication channel, a provisioning request to provision a credential 207 (e.g., a payment credential) of an account (e.g., a payment account) of a user to a mobile device. The first communication channel may comprise a connection from the service provider computer 212 to the application provider computer 211. The provisioning request may include a PAN of the account, and in some embodiments may include a reference identifier of the PAN but not the actual PAN itself. The account may be a credit card account, debit card account, checking or savings account, prepaid account, etc. The credential 207 may include one or more of an account number of the account, a token associated with the account, an expiration date of the token or account number, personal information associated with the account, a public and/or private key to be used to encrypt and/or decrypt information associated with transactions with the account, card art (e.g., an image such as a depiction of an actual credit card or payment device) for the account, an identifier and/or name of a user associated with the account, an identifier and/or name of an issuer associated with the account, etc.

At block 604, the flow 600 includes determining a risk level associated with the provisioning request. This determination of the risk level may include performing a risk check or risk analysis for the requesting user, account, card, mobile device, or any other data that is present in the received provisioning request (e.g., the CVV2 value, a ZIP Code, a user identifier, etc.) or is tied to the consumer's account associated with the provisioning request (e.g., previously registered/provisioned card data, etc.). The model used for the risk analysis may be configured according to the desires of the operator, and may take into consideration historical information provided by the application provider computer 211 (e.g., a wallet provider) in each request (e.g., how long the account has been opened, how many cards the consumer used, a number or amount of purchases in the past, etc.). The model may also combine payment processing network data regarding spending patterns on the account and network level fraud trends (e.g. data compromise trends, common merchants/categories of spend).

At decision block 606, the flow 600 includes a determination of whether the risk level is below, within, or above a predetermined risk threshold range. In some embodiments, the risk level is set to be “high” (i.e., above the risk threshold range), “medium” (i.e., within the risk threshold range), or “low” (i.e., below the risk threshold range). In some embodiments, the risk threshold range defines a range of values that delineate at least three categories of risk values. For example, in an embodiment where generated risk values are numbers between 0 and 100, the predetermined risk threshold range may be configured as [25, 50], and thus, any generated risk value score that is greater than or equal to 25 and less than or equal to 50 will be considered “medium” risk, and any risk score above that range (i.e., greater than 50) is considered “high” risk, and any risk score below that range (i.e., less than 25) is considered “low” risk. Of course, other predetermined risk threshold ranges may be configured using other ranges/cutoff points, and may be configured according to different types of generated risk scores (e.g., integers, real numbers, letters, etc.) and schemes.

In the depicted embodiment, if the risk level is deemed below the predetermined risk threshold range (i.e., is “low” risk), the flow 600 includes causing, at block 608, the credential 207 to be provisioned to the mobile device. In some embodiments, this includes transmitting a set of one or more provisioning scripts to be executed by the mobile device to cause the credential 207 to be provisioned in an activated state (e.g., at block 609). In some embodiments, this transmission is made with the application provider computer 211 (e.g., a wallet provider) as the destination, and the application provider computer 211 then forwards on the set of provisioning scripts to the mobile device for execution. In some embodiments, the set of provisioning scripts includes a personalization script including account provisioning data and an activation script that, when executed, causes the provisioned account credential 207 to be provisioned in the active state (i.e., is able to be used by the mobile device for payment transactions). In other embodiments, the set of provisioning scripts includes just one script that provisions the account credential(s).

In the depicted embodiment, if the risk level is deemed to be above the predetermined risk threshold range (i.e., is “high” risk), the flow 600 includes at block 610, transmitting a provisioning request denial message indicating that the provisioning request is denied. In some embodiments, the provisioning request denial message is transmitted to an application provider computer 211 (e.g., a wallet provider), which then forwards on the provisioning request denial message to the mobile device of the user or otherwise transmits a message to the mobile device to indicate that the provisioning request has been denied.

If, in the depicted embodiment, the risk level is deemed to be within the predetermined risk threshold range (i.e., is “medium” risk), the flow 600 continues with an optional optimization at block 612 of transmitting a set of provisioning scripts to be executed by the mobile device to cause the credential 207 to be stored on the mobile device in a partially active state. In some embodiments, the set of provisioning scripts includes a personalization script that, when executed, provisions the credentials 207 in an partially active state such that the credential 207 can be used by the mobile device for a restricted set of transactions. For example, in some embodiments the provisioned credential 207 is modified (e.g., digits changed otherwise transformed) to be recognizable as a partially active credential 207. In some embodiments a protection flag is set (e.g., within a mobile device 101 secure element 202) such that the mobile device 101 can only access the credentials 207 for qualifying purchases, or such that the mobile device 101 transmits a notification that the credentials 207 are partially active when they are being used for a transaction. For example, the credentials 207 may be accessed and used for transactions below a certain amount, transactions in a certain area or at a certain merchant, or transactions that fall within any other suitable type of restriction. Providing such a partially active credential 207 may improve efficiency and user experience, as the user may be immediately able to use the credential 207 instead of first having to go through authentication processes.

In some embodiments, the credentials 207 may be stored on the mobile device in a fully active state, but the application provider computer 211, service provider computer 212, and/or authorizing entity computer 106 may flag the credential 207 as partially active, and may only authorize transactions that fall within the credential's 207 restrictions. For example, the service provider computer 212 can store a credential record indicating that the credential stored on the mobile device is associated with a partially active state.

In some embodiments, the performance of block 612 allows for some credential-provisioning work to be performed “early” (i.e., before a time the credential is actually allowed to be activated), which can distribute the required workload from a time perspective by allowing these potentially relatively computationally expensive steps to be performed early and just using a relatively computationally lightweight script to be executed later on (e.g., at block 530) to fully activate the pre-provisioned partially active account credentials.

At block 614, the flow 600 includes causing an authentication process to be performed with the user 107. In some embodiments, this authentication process comprises, at block 616, causing a dynamic verification value (DVV) to be provided to the user via a second communication channel. In some embodiments, the second communication channel includes a communication between an authorizing entity computer 106 of the account with the user 107, and may not include any direct communication between the service provider computer 212 and the user 107 or between the service provider computer 212 and application provider computer 211. In some embodiments, this communications channel includes the issuer transmitting an SMS message, an email, placing or receiving a telephone call with the user, transmitting a webpage to the user, etc. In some embodiments, the DVV comprises a one-time password (OTP). The OTP, in some embodiments, is generated by the service provider computer 212, and in some embodiments is generated by the authorizing entity computer 106. In some embodiments, the service provider computer 212 generates (or acquires) the OTP and provides it (at block 618) to the authorizing entity computer 106 managing the user's account for delivery to the user. In some embodiments, the authorizing entity computer 106 generates the OTP and transmits the OTP to both the user 107 (via the second communications channel) as well as to the service provider computer 212 to enable the service provider computer 212 to later validate a user's entry of the OTP. However, in some embodiments the authorizing entity computer 106 generates the OTP but does not need to provide the OTP to the service provider computer 212. For example, authorizing entity computer 106 may generate the OTP according to a determined algorithm so that the OTP can be verified by the service provider computer 212 based upon the service provider computer 212 generating the OTP again using the same algorithm, for example. Thus, at some point after the user 107 is provided with the DVV via the second communications channel, the user 107 may provide the DVV back via the mobile device 101. This may cause the mobile device 101 to send the entered DVV to the application provider computer 211, which in turn may generate and transmit a user verification response message including the entered DVV to the service provider computer 212 at block 620.

At block 622, the flow 600 includes determining whether the authentication process was successful. For example, the determining may include a determination of whether the user-entered DW within the user verification response message is the “correct” dynamic verification value. In some embodiments, this determination comprises looking up a stored copy of the DVV (e.g., generated by the service provider computer 212, authorizing entity computer 106, or third-party) and comparing it to the received DVV to determine if they are the same. In some embodiments, this determination comprises using a DVV-generation algorithm (e.g., that was previously used to generate the DVV) to generate the DVV and compare the generated DVV to the received user-entered DVV. In some embodiments, when the user-entered DVV within the user verification response message is not the same as the “correct” DVV, the authentication process is deemed to have failed, and flow continues at block 624, where an error message is sent. In some embodiments, this message is transmitted to the application provider computer 211 and/or authorizing entity computer 106.

However, in some embodiments when the authentication process is deemed to have succeed (e.g., the user-provided DVV is the same as the “correct” DVV), the flow 600 continues with block 626, which includes causing the credential 207 to be provisioned onto the mobile device. In some embodiments, this includes causing the credential 207 (previously) provisioned onto the mobile device to be switched from the partially active state to a fully active state (e.g., at block 628), which may include de-modifying a token or PAN of the account, changing a data protection flow (e.g., within a secure element 202) such that the credential 207 can be accessed for all transactions instead of a limited subset of transactions, etc. This case also include lifting restrictions stored at the backend (e.g., at the application provider computer 211, the service provider computer 212, and/or the authorizing entity computer 106). For example, the service provider computer 212 can update a credential record to indicate that the credential is now in a fully active state, and no longer in a partially active state. In some embodiments, this provisioning includes at block 630 transmitting an activation script to be executed by the mobile device. In some embodiments, the activation script is sent to application provider computer 211, which in turn provides the activation script to the mobile device 101, causing the activation script to be executed and thus the credentials 207 fully activated. In some embodiments, the service provider computer 212 also receives a token activation result message 381 from application provider computer 211 indicating whether the provisioning was successful, and may forward this message 382 on to the authorizing entity computer 106. In some embodiments, the service provider computer 212 may also transmit a token notification message 379 to the authorizing entity computer 106 to inform the authorizing entity computer 106 of the token and the account that it is associated with.

FIG. 7 illustrates a combined sequence and flow diagram depicting two dynamic verification value validation configurations 700A-700B in an account provisioning system according to some embodiments of the present invention. In some embodiments, the first DVV variant 520 of FIG. 5 is replaced with one of second DVV variant 700A or third DVV variant 700B. However, these are just a few DVV variants possible, and other variants may be utilized that may or may not include features from these variants. Both the second and third DVV variants 700A-700B begin after the service provider computer 212 has received a DVV delivery choice message 576 from the application provider computer 211.

The second DVV variant 700A includes—instead of generating a DVV as in block 522 of FIG. 5—transmitting a DVV request message 750 (including the delivery choice indicated in the DVV delivery choice message 576) to the authorizing entity computer 106, which itself will generate the DVV at block 702, provide the DVV to the user at block 580 according to the delivery choice over the second communications channel, and return the generated DVV in message 752 to the service provider computer 212. The service provider computer 212 may store this DVV at block 704. After the user has received the DVV over the second communications channel, the user will enter the DVV into the mobile device 101 (e.g., using a mobile wallet application), which will send the entered-DVV in a message 582 to the application provider computer 211. The application provider computer 211 will then transmits a resume account message 584 including the DVV to the service provider computer 212, which can determine the validity of the authentication by validating the DVV at block 706, which includes comparing the stored DVV (from block 704) with the received user-entered DVV (from message 584). If the values match or are otherwise deemed equivalent, the DVV is validated and thus the authentication succeeds; otherwise, the DVV is not validated and the authentication fails.

The third DVV variant 700B is similar to the second DVV variant 700A aside from a few key differences. First, in the third DW variant 700B, the authorizing entity computer 106 does not report the generated DVV back to the service provider (see message 752 of the second DVV variant 700A). Instead, when the service provider computer 212 receives the resume account message 584 including the user-entered DVV, the service provider computer 212 may validate the DVV at block 708 according to an algorithm. In some embodiments, the authorizing entity computer 106 generates the DVV 702 using a particular algorithm that is known to the service provider computer 212 such that the service provider computer 212 can either re-generate the DVV itself (using the same algorithm) or invert the algorithm such that it can “undo” the user-provided DVV value to arrive at a clear text value, and then test the clear text value to determine whether it formatted properly. For example, in an embodiment the authorizing entity computer 106 may generate the DVV 702 by encrypting (with an authorizing entity computer 106 private key) a clear text value that is based upon a value associated with the user (e.g., a PAN of the account, a user identifier, etc.) and further based upon a current date or time value, for example (of course, many other possibilities exist for creating clear text values, and this provided example is simply illustrative of one possible use case). Thus, the service provider computer 212 may have access to a public key of the authorizing entity computer 106, decrypt the user-provided DVV, and determine whether the resulting clear text value includes the correct PAN and a correct date/time value.

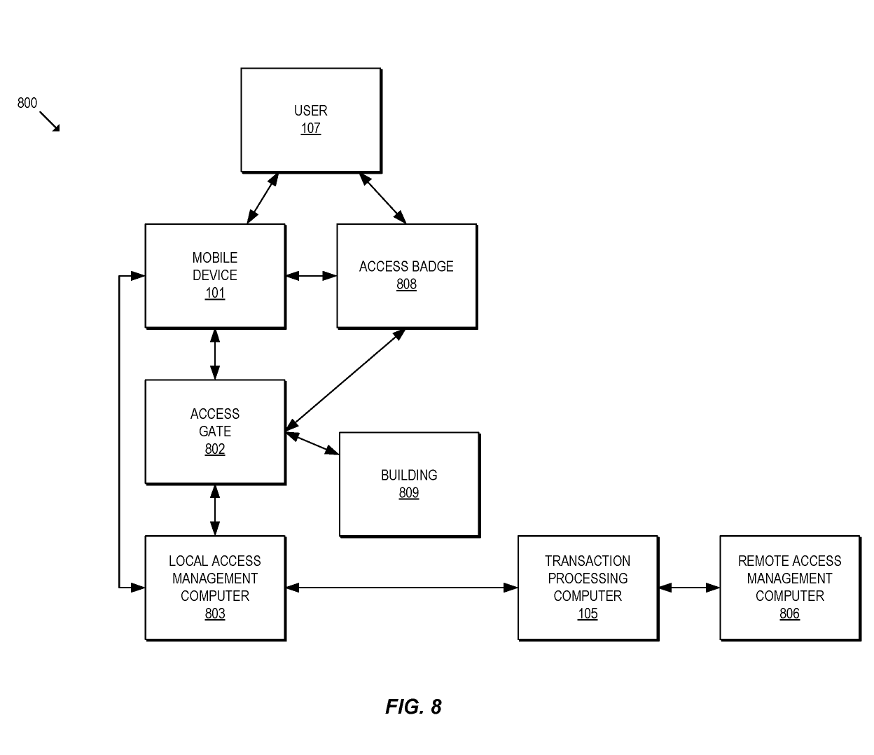

As mentioned above, embodiments of the invention can apply to any suitable credentials, or tokens representing credentials, provisioned onto a mobile device. A specific example is now described of a system for accessing a secure area such as a building. FIG. 8 illustrates a block diagram of a transaction system for accessing a building, according to an embodiment of the invention.

FIG. 8 shows a system 800 including a user 107, an access badge 808, a mobile device 101, an access gate 802, a building 809, a local access management computer 803, a transaction processing computer 105, and a remote access management computer 806.

If the access gate 802 receives a valid access code, it can open a passage way (e.g., by unlocking a door or raising a barrier) that allows the user 107 to access the building 809. The access badge 808 can store a valid access code, and the user 107 can present the access badge 808 to the access gate 802 so that the access badge 808 transmits the access code to the access gate 802. Also, the access code (or a token representing the access code) can be provisioned onto the mobile device 101, and the mobile device 101 can similarly provide the access code to the access gate 802.

In some embodiments, the access gate 802 can store a local database of valid access codes, compare a received access code to codes in the database. If the received access code matches a stored access code, the access gate 802 can grant access to the building.

In other embodiments, the access gate 802 can forward a received access code to a local access management computer 803 (e.g., located somewhere in the building). The local access management computer 803 can determine whether or not the access code is valid and whether to grant access to the user 107. The local access management computer 803 can inform the access gate 802 whether or not to grant access to the user 107.

In other embodiments, the access code can be sent to a remote access management computer 806 (e.g., by the access gate 802 and/or the local access management computer 803). The remote access management computer 806 can be located remotely relative to the building 809. The remote access management computer 806 can manage access grants for multiple buildings 809 and other secure areas. For example, the remote access management computer 806 can be a secure computer that issues and manages access codes from a secure location. The remote access management computer 806 can determine whether or not the access code is valid and whether to grant access to the user 107. The remote access management computer 806 can inform the access gate 802 whether or not to grant access to the user 107.

In some embodiments, the transaction processing computer 105 can forward an access request message for an access transaction from the access gate 802 to the remote access management computer 806. Additionally, the transaction processing computer 105 can provide provisioning and/or tokenization services. For example, the transaction processing computer 105 can provision the access code to the mobile device 101. Additionally, the transaction processing computer 105 can generate and/or provision a token representing the access code to the mobile device 101. The transaction processing computer 105 can also de-tokenize a token for a corresponding access code during an access transaction.

The transaction processing computer 105 can also mark an access code record as partially active. This can indicate that an access code (or token) provisioned to the mobile device 101 can be used for restricted access (e.g., access to a building lobby), but not for full access (e.g., access to a secure office). Once the provisioned access code is fully activated (e.g., the record marked as fully active), some or all restrictions can be lifted, such that the provisioned access code can be used to reach more areas or all areas of the building.

In other embodiments, records of token status (e.g., partial active status or fully active status) can be maintained and updated at the access gate 802, the local access management computer 803, the remote access management computer 806, and/or any other suitable entity or computer.

The various participants and elements described herein may operate one or more computer apparatuses to facilitate the functions described herein. Any of the elements in the above-described FIGS. 1-6, including any servers or databases, may use any suitable number of subsystems to facilitate the functions described herein.

A computer system will now be described that may be used to implement any of the entities or components described herein. Subsystems in the computer system are interconnected via a system bus. Additional subsystems include a printer, a keyboard, a fixed disk, and a monitor which can be coupled to a display adapter. Peripherals and input/output (I/O) devices, which can couple to an I/O controller, can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method, comprising:
receiving, at a server computer, a provisioning request to provision a credential to a mobile device, wherein the credential is associated with an account of a user;
transmitting, by the server computer, provisioning scripts to be executed by the mobile device to cause the credential to be stored at the mobile device; and
storing, by the server computer, a credential record indicating that the credential stored at the mobile device is associated with a partially activate state, such that the mobile device can utilize the credential for restricted transactions.

2. The method of claim 1, further comprising:
receiving, at the server computer, an authorization request message for a transaction, the authorization request message including the credential;
identifying, by the server computer, the credential record based on the credential;
determining, by the server computer, based on the credential record, that the credential stored at the mobile device is associated with the partially activate state;
determining, by the server computer, that the transaction qualifies as a restricted transaction; and
forwarding, by the server computer, the authorization request message to an authorizing entity, wherein the authorizing entity authorizes the transaction based on the credential.

3. The method of claim 2, wherein the credential is an access code, and wherein authorizing the transaction includes granting access to a building based on the access code.

4. The method of claim 1, further comprising:
receiving, at the server computer, an authorization request message for a transaction, the authorization request message including the credential;
identifying, by the server computer, the credential record based on the credential;
determining, by the server computer, based on the credential record, that the credential stored at the mobile device is associated with the partially activate state;
determining, by the server computer, that the transaction does not qualify as a restricted transaction; and
declining, by the server computer, the transaction.

5. The method of claim 1, further comprising:
causing, by the server computer, an authentication process to be performed with the user; and
responsive to authenticating the user, updating, by the server computer, the credential record to indicate that the credential stored at the mobile device is associated with a fully active state.

6. A server computer comprising:
a processor; and
a computer readable medium, the computer readable medium comprising code, executable by the processor, for implementing a method comprising:
receiving a provisioning request to provision a credential to a mobile device, wherein the credential is associated with an account of a user; and
transmitting provisioning scripts to be executed by the mobile device to cause the credential to be stored at the mobile device; and
storing a credential record indicating that the credential stored at the mobile device is associated with a partially activate state, such that the mobile device can utilize the credential for restricted transactions.

7. The server computer of claim 6, further comprising:
receiving an authorization request message for a transaction, the authorization request message including the credential;
identifying the credential record based on the credential;
determining based on the credential record, that the credential stored at the mobile device is associated with the partially activate state;
determining that the transaction qualifies as a restricted transaction; and
forwarding the authorization request message to an authorizing entity, wherein the authorizing entity authorizes the transaction based on the credential.

8. The server computer of claim 7, wherein the credential is an access code, and wherein authorizing the transaction includes granting access to a building based on the access code.

9. The server computer of claim 6, further comprising:
receiving an authorization request message for a transaction, the authorization request message including the credential;
identifying the credential record based on the credential;
determining based on the credential record, that the credential stored at the mobile device is associated with the partially activate state;
determining that the transaction does not qualify as a restricted transaction; and
declining the transaction

10. The server computer of claim 6, further comprising:
causing an authentication process to be performed with the user; and
responsive to authenticating the user, updating, by the server computer, the credential record to indicate that the credential stored at the mobile device is associated with a fully active state.

11. A method comprising:
receiving, by a mobile device, provisioning scripts for provisioning a credential associated with an account of a user; and
executing, by the mobile device, the provisioning scripts such that the credential is stored at the mobile device, wherein a server computer stores a credential record indicating that the credential stored at the mobile device is associated with a partially activate state, such that the mobile device can utilize the credential for restricted transactions.

12. The method of claim 11, further comprising:
providing, by the mobile device, the credential to an access device for a transaction, wherein the credential is sent in an authorization request message to the server computer, wherein the server computer identifies the credential record based on the credential, wherein the server computer determines, based on the credential record, that the credential stored at the mobile device is associated with the partially activate state, wherein the server computer determines that the transaction qualifies as a restricted transaction, wherein the server computer forwards the authorization request message to an authorizing entity, and wherein the authorizing entity authorizes the transaction based on the credential.

13. The method of claim 12, wherein the credential is an access code, and wherein authorizing the transaction includes granting access to a building based on the access code.

14. The method of claim 11, further comprising:
providing, by the mobile device, the credential for a transaction, wherein the credential is sent in an authorization request message to a server computer, wherein the server computer identifies the credential record based on the credential, wherein the server computer determines, based on the credential record, that the credential stored at the mobile device is associated with the partially activate state, wherein the server computer determines that the transaction does not qualify as a restricted transaction, and wherein the server computer declines the transaction.

15. The method of claim 11, further comprising:
engaging, by the mobile device, in an authentication process, wherein responsive to user authentication, the server computer updates the credential record to indicate that the credential stored at the mobile device is associated with a fully active state.

16. A mobile device comprising:
a processor; and
a computer readable medium, the computer readable medium comprising code, executable by the processor, for implementing a method comprising:
receiving provisioning scripts for provisioning a credential associated with an account of a user; and
executing the provisioning scripts such that the credential is stored at the mobile device, wherein a server computer stores a credential record indicating that the credential stored at the mobile device is associated with a partially activate state, such that the mobile device can utilize the credential for restricted transactions.

17. The mobile device of claim 16, further comprising:
providing the credential to an access device for a transaction, wherein the credential is sent in an authorization request message to the server computer, wherein the server computer identifies the credential record based on the credential, wherein the server computer determines, based on the credential record, that the credential stored at the mobile device is associated with the partially activate state, wherein the server computer determines that the transaction qualifies as a restricted transaction, wherein the server computer forwards the authorization request message to an authorizing entity, and wherein the authorizing entity authorizes the transaction based on the credential.

18. The mobile device of claim 17, wherein the credential is an access code, and wherein authorizing the transaction includes granting access to a building based on the access code.

19. The mobile device of claim 16, further comprising:
providing the credential for a transaction, wherein the credential is sent in an authorization request message to a server computer, wherein the server computer identifies the credential record based on the credential, wherein the server computer determines, based on the credential record, that the credential stored at the mobile device is associated with the partially activate state, wherein the server computer determines that the transaction does not qualify as a restricted transaction, and wherein the server computer declines the transaction.

20. The mobile device of claim 16, further comprising:
engaging in an authentication process, wherein responsive to user authentication, the server computer updates the credential record to indicate that the credential stored at the mobile device is associated with a fully active state.
